(19) United States
(12) Patent Application Publication
(10) Pub. No.: US 2004/0133678 A1
(43) Pub. Date: Jul. 8, 2004

(54) Data processing system, information processing apparatus and method, and computer program

(75) Inventor: Yosuke Tamura, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Sony Corporation, Tokyo (JP)

(21) Appl. No.: 10/674,458

(22) Filed: Oct. 1, 2003

(30) Foreign Application Priority Data
Nov. 6, 2002 (JP) 2002-322098

(51) Int. Cl. G06F 15/173; G06F 17/30; G06F 7/00

(52) U.S. Cl. 709/225; 707/3; 707/10

(57) ABSTRACT

A data processing system includes a plurality of chain objects each of which is given a unique ID, a chain manager arranged so as to correspond to each chain object for performing control of a process involving the chain objects, a chain directory for storing service information executable by each chain object, and a root chain manager for performing control of service execution by performing an ID acquisition process for each chain object, querying the chain directory about an executable data processing service involving a chain object having the acquired ID, and further circulating chain tokens among chain managers corresponding to the chain objects participating in the service based on a reply to the query, whereby various configurations for providing and receiving services are implemented.

### CROSS REFERENCES TO RELATED APPLICATIONS

The present invention claims priority to its priority document No. 2002-322098 filed in the Japanese Patent Office on Nov. 6, 2002, the entire contents of which being incorporated by reference herein.

### BACKGROUND OF THE INVENTION

1. Field of the Invention

The present invention relates to a data processing system, an information processing apparatus and method, and a computer program. More particularly, the invention relates to a data processing system, an information processing apparatus and method, and a computer program, which connect information processing apparatuses or any objects other than the information processing apparatuses as chain objects that are components of a service chain, thereby making it possible to easily perform various data processing involving these connected chain objects, and also to implement a flexible configuration that enables to provide and receive services.

2. Description of Related Art

We benefit much from networking owing to the ever-proliferating Internet for sharing information, sharing resources and the like. The trend towards networking does not stay with the world of computers but expands to communication processing among home appliances, to communication by portable telephones connected to the Internet. Even the Internet-based communication, which involves refrigerators, microwaves and the like equipped with communication means, is proposed and are on their way to commercialization.

Specifically, studies are positively made on the realization of a so-called ubiquitous environment, or an environment that allows communications with anybody or anything whenever and wherever desired over a network. The ubiquitous environment involves any object equipped with a computer to implement services via a network. In such an environment with omnipresence computers, it would be crucial to enhance their convenience by utilizing a superior user interface. In fact, in the field of ubiquitous technology, user-side technology such as virtual reality and real world-oriented interface has been advanced ahead of service infrastructure.

On the other hand, the existing service infrastructure is designed basically for the Internet with personal computers and intelligent home appliances in mind, and such a service infrastructure does not fully support the minutely evolving user-side ubiquitous environment. One reason is that the ubiquitous environment stresses importance of easy control over countless objects found in front of us, whereas the conventional Internet-based services are oriented towards provision of a single service in a wide environment.

However, also much discussed nowadays are integrative approaches intended for provision of services under the ubiquitous environment. Some typical examples include SLP (Service Location Protocol) proposed by IETF (Internet Engineering Task Force) (see, e.g., non-patent literature 1), Jini by Sun Microsystems (see, e.g., non-patent literature 2), UPnP (Universal Plug and Play) by Microsoft Corporation (see, e.g., non-patent literature 3), INS (Intentional Naming System) by Massachusetts Institute of Technology (see, e.g., non-patent literature 4), and Ninja by University of California, Berkeley (see, e.g., non-patent literature 5).

{Non-Patent Document 1}

W. Weiser. Some Computer Science Issues in Ubiquitous Computing. Communication of the ACM, July 1993.

{Non-Patent Document 2}

Sun. Jini connection technology. In Sun Microsystems, http://www.sun.com/jini/, 2000.

{Non-Patent Document 3}

Microsoft Corporation. Understanding Universal Plug and Play: A White Paper.

{Non-Patent Document 4}

W. Adjie-Winoto, E. Schewarts, H. Balakrishnan, and J. Lilley. The Design and Implementation of an International Naming System. In Proceedings of ACM Symposium on Operating Systems Principles, December 1999.

{Non-Patent Document 5}

S. Gribble, et al. The Ninja Architecture for Robust Internet-Scale Systems and Services. Special Issue of IEEE Computer Networks on Pervasive Computing, June 2000.

All of these conventionally proposed service providing systems have a common basic scheme despite of difference in their purposes. That is, the common scheme includes the following two steps. As a first step, (1) service providing apparatus announces its existence to the other apparatus. This may be done in various modes. For example, these modes may be classified into the following three modes: registration in an apparatus that provides a directory service; periodic advertisement of service to a particular channel or address; or standby at a particular channel or address and reply to indicate its own existence if requested.

As a second step, (2) a client finds a service providing apparatus. This can be done in various modes. For example, these modes may be classified into three modes: querying an apparatus that provides the directory service; transmitting a request packet to a particular channel or address, or listening advertisement of a service providing apparatus at a particular channel or address. In terms of communication modes, the directory service-based mode and the pier-to-pier mode are available. Hybrid systems operable on both communication modes are also available. The former involves the apparatus that provides directory service between the client and the service providing apparatus. The latter provides services through direct mutual recognition between the client and the service providing apparatus.

In the existing technology, there is a clear demarcation between the service providing apparatus and the client. That is, the service providing apparatus is designed specifically to provide the client with services. However, in some situations, we do not want to have our nearby apparatus, which serves as a client, to receive the service. In other situations, we often wish to have apparatus defined as a client for exchanging data for us, such as, for example, to send a TV screen directly to a printer or to output from a projector a picture taken by a camera at a remote location.

### SUMMARY OF THE INVENTION

The present invention is made in view of the above described problems, and provides a data processing system, an information processing apparatus and method, and a computer program for implementing a system infrastructure with a superior expendability with emphasis placed on performing various processing by controlling any objects that may be found around a client so as to allow them to communicate with one another, and for providing and receiving flexible services on that infrastructure. The objects may include information processing apparatuses such as displays, printers, PCs, PDAs, speakers, intelligent home appliances, as well as apparatus other than these information processing apparatuses, goods, living things, books, stones and the like.

Furthermore, an object of the present invention is to implement a novel type of service by adding identifiers not only to electronic apparatus covered by the conventional technology, such as PCs and home appliances, but also to other apparatus, goods, living things, books, stones, walls and the like, thereby introducing them into the world of a service chain (Service-Chain) for realizing the processes of providing and receiving various services, and assimilating them into the existing Internet infrastructure where they are connected to other objects so as to allow them to communicate with one another.

It should be noted that a service architecture, proposed by the present invention and adapted to a ubiquitous environment for realizing a configuration for providing and receiving service with connections of objects, will be called a service chain (Service-Chain).

A first aspect of the present invention provides a data processing system which includes: a plurality of chain managers for performing service control of a data input and/or data output, the data input and data output handling data associating with one or more chain objects and having a predefined file format and/or data type; a chain directory for storing correspondence data and performing an executable service retrieval process, the correspondence data storing correspondence relations among identifiers (ID) set on the chain managers, identifiers (ID) of chain objects associating with the chain mangers, data input and/or data output services associated with the chain objects, and file formats and/or data types that can be used in the data input and/or data output services, the executable service retrieval process being performed by matching of the file formats and/or data types and matching of the services of the data input and the data output; and a root chain manager for acquiring one chain object ID and performing a query process to the chain directory, the query process inquiring a chain object that uses the data output or data input service having the same file format and/or data type as that of the data input or data output service associating with the chain object with the acquired ID, wherein the chain manager ID and the chain object ID are identifiers that are defined in address spaces different from each other.

In one embodiment of the data processing system of the present invention, the root chain manager is configured to generate a service query packet to perform the query process to the chain directory, and the chain directory is configured to generate a chain list that records packet reception time information of the service query packet received from the root chain manager and ID information stored in the service query packet, perform an executable service retrieval process for searching an service that is executable among two chain objects that can be combined based on the IDs recorded in the chain list, and generate a reply to the service query packet based on a result of the executable service retrieval process, wherein the executable service retrieval process is performed if another service query packet storing a different chain object ID is received from the same root chain manager within a predetermined threshold time.

In another embodiment of the data processing system of the present invention, the chain manager ID is an ID that is applicable as a communication address.

In still another embodiment of the data processing system of the present invention, the root chain manager is configured to control the service execution by circulating a chain token among the chain managers corresponding to the chain objects participating in the service based on the reply to the service query packet to the chain directory.

In yet another embodiment of the data processing system of the present invention, the root chain manager is configured to control the service execution by circulating a first and a second chain tokens among the chain managers corresponding to the chain objects participating in the service, wherein the first chain token is for acquiring program information necessary for performing the service and the second chain token is for requesting start of the program corresponding to the service execution process.

In even another embodiment of the data processing system of the present invention, the chain manager is configured to store an ID of the chain object it manages and service profile information as executable service information, and performs an ID notification process, a data storage process, and a program triggering process. The notification process is performed for the ID of the chain object it manages based on the service profile information in response to the request of an ID acquisition process from the root chain manager. The data storage process is performed for a received chain token based on the service profile information in response to the received chain token from the root chain manager. The program triggering process is performed based on the received chain token.

A second aspect of the present invention provides an information processing apparatus serving as a chain manager arranged so as to correspond to each of a plurality of chain objects, the chain object being arranged within a service chain that is included in a data processing system. The information processing apparatus includes: memory means for storing an ID set on the chain object, and service profile information as executable service information; and control means for performing a data storage process for a received chain token based on the service profile information in response to the chain token received from a root chain manager arranged within the service chain, and a program triggering process based on the received chain token.

In one embodiment of the information processing apparatus of the present invention, the control means is configured to perform a process for storing program information, which is required for performing a service stored in the service profile information, in a first chain token received from the root chain manager for acquiring the program information required for performing the service.

In another embodiment of the information processing apparatus of the present invention, the control means is configured to acquire program information necessary for performing a service stored in a second chain token in response to reception of the second chain token, which is received from the root chain manager for requesting start of a program corresponding to a service execution process, and perform a program execution process based on the acquired program information.

A third aspect of the present invention provides an information processing apparatus serving as a root chain manager for performing control of data processing service involving a plurality of chain objects, the chain objects being arranged in a service chain that is included in a data processing system. The information processing apparatus includes: control means for performing an ID acquisition process for the chain objects; generating a service query packet for inquiring an executable data processing service to which the chain object with the acquired ID is applied, and transmitting the service query packet to a chain directory that has service information; and circulating a chain token among chain managers arranged so as to correspond to chain objects participating in the service based on a reply to the query packet; thereby performing control of service execution.

In one embodiment of the information processing apparatus of the present invention, the apparatus is configured to perform a process of circulating a first and a second chain tokens among the chain managers corresponding to the chain objects participating in the service. The first chain token is for acquiring program information necessary for performing the service, and the second chain token is for requesting start of a program corresponding to a service execution process.

A fourth aspect of the present invention provides an information processing apparatus serving as a chain directory for performing an information providing process as to a data processing service involving a plurality of chain objects arranged in a service chain that is included in a data processing system. The information processing apparatus includes: a database for storing service information executable by each chain object in association with an ID of the chain object; and control means for performing a retrieval process on the database that stores the service information in response to a service query packet storing a plurality of chain object IDs, based on the IDs, and generating a service query reply packet that stores executable service information acquired as a result of the retrieval process.

In one embodiment of the information processing apparatus of the present invention, the apparatus is configured to have information, as the service information, which indicates association of an ID of each chain object, service information executable by each of the chain objects, and address information of the chain manager arranged on the chain object. Furthermore, the apparatus is configured to search the service information that corresponds to the chain object IDs stored in the service query packet based on the service information in response to reception of the service query packet, generate the service query reply packet storing the searched service information, and transmit it to the root chain manager.

In another embodiment of the information processing apparatus of the present invention, the service information stored in the database includes a service type and a data format that can be processed, the service type indicating whether a service executable by each of the chain objects is a data input mode or a data output mode. The control means is configured to perform a matching process for searching a combination of the same data formats that allow a data input and a data output among the service information corresponding to the chain object IDs stored in the service query packet in response to the received service query packet, and generate a reply to the service query packet, the reply including the matched service as an executable data processing service.

In still another embodiment of the information processing apparatus of the present invention, the control means is configured to generate a chain list recording packet reception time information in response to reception of the service query packet received and ID information stored in the service query packet, perform an executable service retrieval process for searching an service that is executable among two chain objects that can be combined based on the IDs recorded in the chain list, and generate a reply to the service query packet based on a result of the executable service retrieval process, wherein the executable service retrieval process is performed if another service query packet storing a different chain object ID is received from the same root chain manager within a predetermined threshold time.

A fifth aspect of the present invention provides a data processing method for a service chain including a plurality of chain objects, the each chain object being given a unique ID. The data processing method includes: an ID acquiring step for acquiring an ID of the chain object; a query execution step for transmitting a service query packet storing the ID acquired by the ID acquiring step to a chain directory that has service information; a query reply step for searching service information corresponding to the chain object ID stored in the service query packet based on the chain object IDs in the service query packet, performing a retrieval process to search an executable service involving chain objects by performing a matching process for searching a combination of the same data formats allowing a data input and a data output, generating a service query reply packet storing service information as the search result, and replying to a sender of the query; and a control step for performing control of the service execution by circulating a chain token among chain managers corresponding to the chain objects participating in the service based on the information stored in the service query reply packet.

In one embodiment of the data processing method of the present invention, the control step includes a process step for circulating a first and a second chain tokens among the chain managers corresponding to the chain objects participating in the service, wherein the first chain token is for acquiring program information necessary for performing the service and the second chain token is for requesting start of the program corresponding to the service execution process.

In another embodiment of the data processing method of the present invention, the control step includes a step for causing the chain manager to store information necessary for performing a program corresponding to the data processing service in the received chain token.

In still another embodiment of the data processing method of the present invention, the control step includes a step for causing the chain manager to perform a program triggering process based on the received chain token.

In yet another embodiment of the data processing method of the present invention, the query reply step includes a step for generating a chain list recording a reception time information of the service query packet and ID information stored in the service query packet, and a step for performing executable service retrieval process for searching an service that is executable among two chain objects that can be combined based on the IDs recorded in the chain list, and generating a reply to the service query packet based on a result of the executable service retrieval process, wherein the executable service retrieval process is performed if another service query packet storing a different chain object ID is received from the same root chain manager within a predetermined threshold time.

A sixth aspect of the present invention provides a data processing method performed by a chain manager arranged so as to correspond to each of a plurality of chain objects that are included in a service chain, wherein the chain object is given a unique ID. The data processing method includes: a memory step for storing an ID set on the chain object and service profile information as executable service information; and a control step for performing a data storage process to a received chain token based on the service profile information in response to the chain token received from the root chain manager, and a program triggering process based on a received chain token.

In one embodiment of the data processing method of the present invention, the control step includes a process step for storing program information, which is necessary for performing a service stored in the service profile information, to a first chain token received from the root chain manager for acquiring the program information necessary for performing the service.

In another embodiment of the data processing method of the present invention, the control step includes a step for acquiring program information necessary for performing a service, which is stored in a second chain token received from the root chain manager for requesting start of a program corresponding to a service execution process, and performing a program execution process based on the acquired information, in response to the reception of the second chain token.

A seventh aspect of the present invention provides a data processing control method for a data processing service involving a plurality of chain objects that are included in a service chain, wherein each chain object is given a unique ID. The data processing control method includes: a step for performing an ID acquisition process for the chain object; a step for generating a service query packet regarding an executable data processing service involving a chain object having the acquired ID, and transmitting it to a chain directory that has service information; and a control step for performing control of the service execution by circulating a chain token among chain managers arranged so as to correspond to the chain objects participating in the service based on a reply to the service query packet.

In one embodiment of the data processing method of the present invention, the control step includes a process step for circulating a first and a second chain tokens among the chain managers corresponding to the chain objects participating in the service, wherein the first chain token is for acquiring program information necessary for performing the service and the second chain token is for requesting start of the program corresponding to the service execution process.

An eighth aspect of the present invention provides an information provision processing method for a data processing service involving a plurality of chain objects arranged in a service chain that is included in a data processing system. The information provision processing method includes: a step for receiving a service query packet storing a plurality of chain object IDs; a search step for performing a retrieval process in a database based on the IDs stored in the service query packet, wherein the database stores service information executable by each chain object in association with the chain object IDs; a step for generating a service query reply packet storing executable service information acquired as a result of the retrieval process; and a step for transmitting the service query reply packet.

In another embodiment of the information processing apparatus of the present invention, the service information stored in the database includes a service type and a data format that can be processed, the service type indicating whether a service executable by each of the chain objects is a data input mode or a data output mode. The search step includes steps for performing a matching process for searching a combination of the same data formats that allow a data input and a data output among the service information corresponding to the chain object IDs stored in the service query packet, and extracting a matched services as the executable data processing service.

In another embodiment of the data provision processing method of the present invention, the data provision processing method further includes process steps for generating a chain list recording packet reception time information in response to reception of the service query packet received and ID information stored in the service query packet, performing an executable service retrieval process for searching an service that is executable among three or more chain objects, that include the ID recorded in the chain list, and generating a reply to the service query packet based on a result of the executable service retrieval process, wherein the executable service retrieval process is performed if another service query packet storing a different chain object ID is received from the same root chain manager within a predetermined threshold time.

A ninth aspect of the present invention provides a computer program for performing a data process performed by a chain manager arranged so as to correspond to each of a plurality of chain objects that are included in a service chain, wherein the chain object is given a unique ID. The computer program includes: a memory step for storing an ID set on the chain object and service profile information as executable service information; and a control step for performing a data storage process to a received chain token based on the service profile information in response to the chain token received from the root chain manager, and a program triggering process based on a received chain token.

A tenth aspect of the present invention provides a computer program for performing a data processing control process for a data processing service involving a plurality of chain objects that are included in a service chain, wherein each chain object is given a unique ID. The computer program includes: a step for performing an ID acquisition process for the chain object; a step for generating a service query packet regarding an executable data processing service involving a chain object having the acquired ID, and transmitting it to a chain directory that has service information; and a control step for performing control of the service execution by circulating a chain token among chain managers arranged so as to correspond to the chain objects participating in the service based on a reply to the service query packet.

An eleventh aspect of the present invention provides a computer program for performing an information providing process for a data processing service involving a plurality of chain objects arranged in a service chain that is included in a data processing system. The computer program includes: a step for receiving a service query packet storing a plurality of chain object IDs; a step for searching service information corresponding to a chain object ID stored in the service query packet based on the chain object IDs in the service query packet, performing a retrieval process to search an executable service involving chain objects by performing a matching process for searching a combination of the same data formats allowing a data input and a data output, and generating a service query reply packet storing the service information as the search result; and a step for transmitting the service query reply packet.

According to the configuration of the present invention, there are provided the plurality of chain objects each of which is given a unique ID, the chain manager arranged so as to correspond to each chain object for performing control of a process involving the chain objects, the chain directory for storing service information executable by each chain object, and the root chain manager for performing control of the service execution by performing an ID acquisition process for each chain object, querying the chain directory about an executable data processing service involving the chain object having the acquired ID, and further circulating chain tokens among chain managers corresponding to the chain objects participating in the service based on a reply to the query, whereby to implement various configurations for providing and receiving services. As a result of this configuration, by setting any object found around a client, such as displays, printers, PCs, PDAs, speakers and intelligent home appliances, as well as apparatus other than these information processing apparatuses, goods, living things, books and stones, as the chain objects, and by arranging the chain managers in association with these objects to control them so as to make them intercommunicatable, various processing can be implemented and a flexible configuration for providing and receiving services can also be realized.

Furthermore, according to the configuration of the present invention, the root chain manager is configured to perform control of the service execution by circulating the first and second chain tokens to the chain managers corresponding to the chain objects participating in the service, the first chain token is circulated for acquiring program information necessary for performing the service and the second chain token for requesting start of a program corresponding to a service execution process. As a result of this configuration, the chain manager may be able to obtain the necessary information to perform the program even if each chain manager does not have information necessary for performing the program beforehand.

Furthermore, according to the configuration of the present invention, the chain directory is configured to perform a matching process for searching a combination of a data input and a data output, both having the same data format, from the service information corresponding to the chain object IDs stored in the service query packet in response to the service query packet from the root chain manager, and to generate a reply to the service query packet, the reply including a matched service corresponding to the data input and output as an executable data processing service. As a result of this configuration, devices can be chained together in such a way that an input and output process of the same data format can be reliably performed, whereby a service providing and receiving process that are free from data processing errors and the like can be accomplished.

Furthermore, according to the configuration of the present invention, the chain directory generates the chain list recording reception time information of the service query packet received from the root chain manager and ID information stored in the service query packet, and performs the service retrieval process to generate a reply to the service query packet, the service retrieval process being performed by searching a service executable among three or more chain objects which can be combined, including the chain objects IDs of which are recorded in the chain list, if a new service query packet storing a different chain object ID is received from a same root chain manager within a predetermined threshold time. As a result of this configuration, the search is possible for a service executable not only between two devices but in combination of two devices among any arbitrary number of devices which is three or more.

It should be noted that the computer program of the present invention includes computer programs that may be provided by a storage medium and a recording medium, such as, for example, a CD, a FD or a MO disc, or by a communication medium such as a network, in a computer readable manner to, for example, general-purpose computer systems which can perform various program codes. By providing this program in the computer readable manner, the processing according to the program can be performed on a computer system.

The above and other objects, features and advantages of the present invention will become more apparent from the following detailed description of the presently exemplary preferred embodiment of the present invention and the accompanying drawings. It should be noted that the term “system” used herein includes a configuration in which a plurality of apparatuses are logically grouped, and is not limited to configurations in which these apparatuses are disposed within the same housing.

### BRIEF DESCRIPTION OF THE DRAWINGS

The above and other objects, features and advantages of the present invention will become more apparent from the following description of the presently preferred exemplary embodiment of the invention taken in conjunction with the accompanying drawing, in which:

FIG. 1 illustrates Chain-Objects (C-Objects) and Chain-Managers (C-Managers);

FIG. 2 shows an exemplary hardware configuration of a C-Manager, a Root Chain-Manager (RC-Manager) and a Root Chain-Object (RC-Object);

FIG. 3 illustrates a relation and a basic operation among respective components for implementing services via a Service-Chain;

FIG. 4 illustrates a specific example of a service utilizing the Service-Chain;

FIG. 5 illustrates a process performed by a video and a projector in order to perform service when the projector is added as a new C-Object;

FIG. 6 is a conceptual diagram showing input {IN} or output {OUT} file formats in which a plurality of C-Objects can perform services, and a matching relation thereof;

FIG. 7 shows an example of a Chain-List which is a history of service requests transmitted from a RC-Manager;

FIG. 8 shows an exemplary process in which a RC-Manager transmits service requests successively to a Chain-Directory (C-Directory);

FIG. 9 illustrates a process of forwarding a Chain-Token;

FIG. 10 shows an exemplary configuration of service profile data for registration in C-Managers;

FIG. 11 illustrates service information about each C-Object held by a C-Directory;

FIG. 12 illustrates specific examples of service profile data for registration in C-Managers and service information held by a C-Directory;

FIG. 13 shows a service request frame format;

FIG. 14 shows a service request reply frame format;

FIG. 15 shows examples of MIME file formats applicable to a configuration of the present invention;

FIG. 16 shows a Chain-Token format;

FIG. 17 illustrates a configuration of a Chain-Token corresponding to execution of a specific service and a process using the Chain-Token;

FIG. 18 is a flow diagram illustrating a service determination process performed by a RC-Manager;

FIG. 19 is a flow diagram illustrating a service request reply process performed by a C-Directory;

FIG. 20 is a flow diagram illustrating how a Chain-Token is processed by a RC-Manager; and

FIG. 21 is a flow diagram illustrating how the Chain-Token is processed by a C-Manager.

### DESCRIPTION OF THE PREFERRED EMBODIMENTS

An information processing system, an information processing apparatus and method, and a computer program according to the present invention will be described in detail with reference to the accompanying drawings. The description will be provided in accordance with the following items listed below.

1. Outline of Service-Chain

2. Basic Technologies in Service-Chain

3. Implementation of Service-Chain

4. Process Flow for Applying Service-Chain

5. Examples of How Service-Chain is Used

1. Outline of Service-Chain

First, a Service-Chain will be outlined. The Service-Chain is a service architecture proposed in the present invention, which is adapted to a ubiquitous environment for implementing a service providing and receiving configuration by connection of objects. Based on the Service-Chain, various processing is implemented by making any objects surrounding a client intercommunicatable. The objects may be displays, printers, PCs, PDAs, speakers and intelligent home appliances, as well as living things, books and stones other than the information processing apparatus, through proper control thereof.

A brief description will be given on basic components of the Service-Chain and then of how service is provided and received through the Service-Chain.

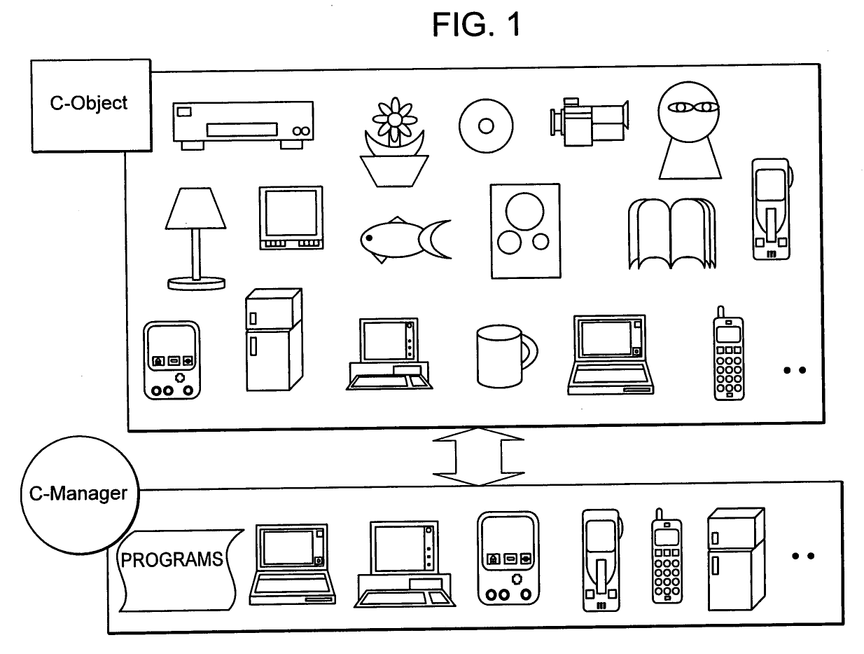

In the Service-Chain, any object that can exchange services is abstracted into a Chain-Object (C-Object). The C-Object is given a unique identifier (ID) in the Service-Chain. FIG. 1 shows an exemplary configuration of C-Objects.

As shown in FIG. 1, an ID is given to any object found around a client, such as displays, printers, PCs, PDAs, speakers, refrigerators and intelligent home appliances, as well as apparatus other than the information processing apparatus, goods, living things, books and stones, as a C-Object. The C-Objects exchange services on the basis of their ID.

All C-objects with their IDs given must, without exception, have one Chain-Manager (C-Manager) corresponding thereto. The C-Manager manages at least one C-Object, and also the ID(s) and other information (profile(s)) of C-Object(s) to be managed. In addition, the C-Manager is also a functional component that receives messages from a Root Chain-Manager (RC-Manager) that serves as a supervising controller of services utilizing the Service-Chain, such as, for example, messages for triggering start, control and end of a service requested by a user, and performs processing based on the received messages, such as, for example, processes of starting, controlling and ending the service.

The C-Manager and the RC-Manager are implemented by means of programs for data processing and hardware for performing the data processing. Basic hardware components include a communication interface for performing processing of transmitting/receiving messages, and a data processing section for performing process on the transmitted/received messages, such as process of starting, controlling and ending a service based on the received messages. Therefore, as shown in FIG. 1, the C-Manager could include, for example, PCs, PDAs, portable telephones, portable communication terminals, intelligent home appliances and the like.

Although the C-Object is shown as separated from the C-Manager in FIG. 1, the C-Manager could be incorporated into the C-Object as long as the C-Object is apparatus that can perform data processing and communication processing, such as a PC or a PDA. In this case, the C-Object and the C-Manager would reside in single apparatus.

That is, a C-Object that can transmit/receive data via the Service-Chain and process the transmitted/received data can function as a C-Manager, and thus can function both as a C-Object and a C-Manager in a stand-alone configuration. That is, a C-Manager can stay within a C-Object as data communication/data processing execution programs.

However, if any C-Objects other than information processing apparatus with no data communication and data processing functions, such as creatures, plants, books and minerals, participate in service provision/reception processing to which the Service-Chain is applied, these C-Objects must be associated with C-Manager(s) implemented by an information processing apparatus such as a PC or a PDA having some communication processing and data processing functions.

Major data processing elements will be described, which are necessary to provide or receive services in the Service-Chain composed of ID-given C-Objects which include information processing apparatuses or objects other than the information processing apparatuses. The major data processing elements include the following three elements.

(1) Root Chain-Manager (RC-Manager)

The RC-Manager is the most important functional element that performs control over the execution of services in the Service-Chain.

The RC-Manager collects the IDs of C-Objects, and requests a Chain-Directory (C-Directory) to find if there is any services that can be implemented using these IDs. Also, based on a reply from the C-Directory to its request, the RC-Manager interacts with a user to prompt the user to select desired service, generates a chain token that stores a message such as one for triggering start, control or end of the service selected by the user, and forwards the generated token to a C-Manager that will be involved in providing the selected service.

(2) Chain-Directory (C-Directory)

The C-Directory is an element that provides a directory service function in the Service-Chain.

The Chain-Directory manages C-Object information, for example, service information that can be provided for each C-Object connected to the Service-Chain, receives a service request from a RC-Manager, searches service(s) in response to the request, and returns implementable service information to the RC-Manager as a reply message.

(3) Chain-Manager (C-Manager)

The C-Manager is a functional element that receives a message (chain token) from the RC-Manager, such as a message serving as a trigger for starting, controlling, or ending a user's desired service, and performs a process based on the received message, such as a process of starting, controlling or ending the service. It should be noted that the C-Manager is also given an ID. The ID of the C-Manager is usable as a communication address such as an IP address, and thus is an identifier defined in an address space different from that for the ID of the C-Object.

All ID-given C-Objects must, without exception, be associated with one C-Manager. Also, any C-Object, which has a display device such as an interactive display, or apparatus that can read IDs, such as, for example, a Bluetooth™ device or a special device equipped with an infrared communication system such as IrDA (Infrared Data Association), has a RC-Manager, and thus can function as a RC-Manager. AC-Object having a RC-Manager will hereinafter be called a Root Chain-Object (RC-Object) since it has a role as a controller of services.

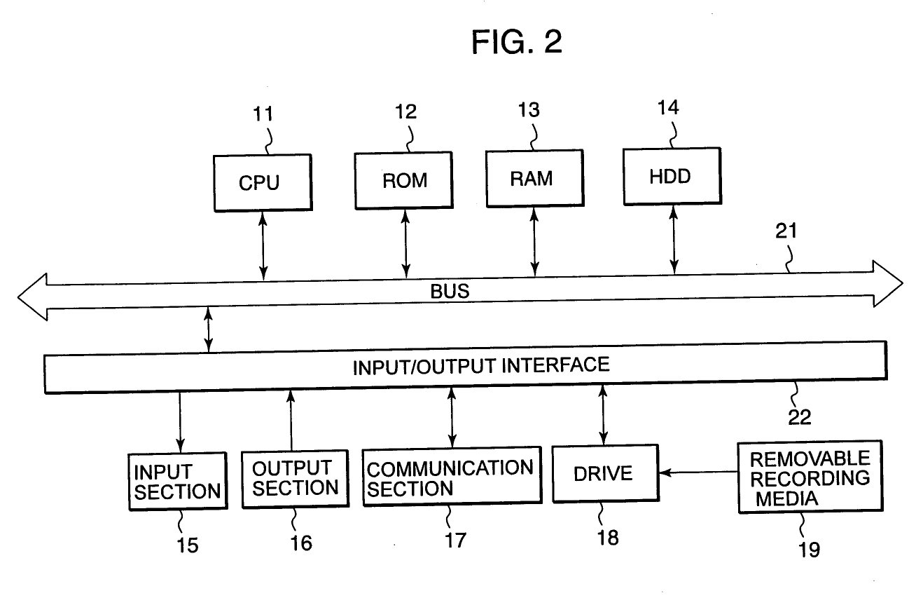

FIG. 2 shows a PC as an exemplary hardware configuration of a C-Manager, a RC-Manager and a RC-Object performing data communication and data processing. FIG. 2 shows an example of a personal computer having a CPU (Central Processing Unit) as control means. The computer is able to perform communication processing and data processing.

In configuration, a CPU 11 performs various programs. A ROM (Read-Only Memory) 12 stores programs performed by the CPU 11 or fixed data as computation parameters. A RAM (Random Access Memory) 13 is used as a storage area and a work area for the programs performed in the processing by the CPU 11, and parameters appropriately changing in the processing of the programs. A HDD 14 performs control of a hard disk, and stores and reads various data and programs on and from the hard disk.

A bus 21 is comprised of a PCI (Peripheral Component Internet/interface) bus or the like, allowing for data forwarding with respective modules and input/output apparatuses via an input/output interface 22.

An input section 15 includes, for example, various switches, buttons, a keyboard and a pointing device. When the input section 15 is manipulated via the buttons and the like, or when data is received from a communication section 17, for example, a command is inputted to the CPU 11 to perform a program stored in the ROM 12. An output section 16 is, for example, a CRT, a liquid crystal display or the like, and displays various information in the form of text, image and the like.

The communication section 17 performs communication with other C-Managers, RC-Managers, RC-Objects, or with Chain-Directories, or communication processing with other entities, for example, content distribution service providers, via the Service-Chain, to transmit data supplied from each storage section or transmit data processed by the CPU 11 or receive data from its counterparts, under control of the CPU 11. The communication section 17 also has a function of reading IDs from ID-given C-Objects.

A drive 18 performs recording and playback on removable recording media 19 such as a flexible disk, a CD-ROM (Compact Disc Read Only Memory), a MO (Magneto-Optical) disk, a DVD (Digital Versatile Disc), a magnetic disk and a semiconductor memory, and reproduces programs or data from each removable recording medium 19 or stores programs or data on the removable recording media 19.

When a program or data recorded on each storage medium is read for execution or processing at the CPU 11, the read program or data is supplied to, for example, the RAM 13 connected via the input/output interface 22 and the bus 21.

It should be noted that the exemplary configuration shown in FIG. 2 is a mere example of apparatus performing the functions of the C-Manager, RC-Manager and RC-Object, and these functions could be performed by various apparatus other than the PC, such as an intelligent home appliance, a PDA and a portable communication terminal, and can thus be configured in hardware for implementing processing according to the type of each apparatus. Furthermore, the C-Directory may also be implemented by the configuration shown in FIG. 2.

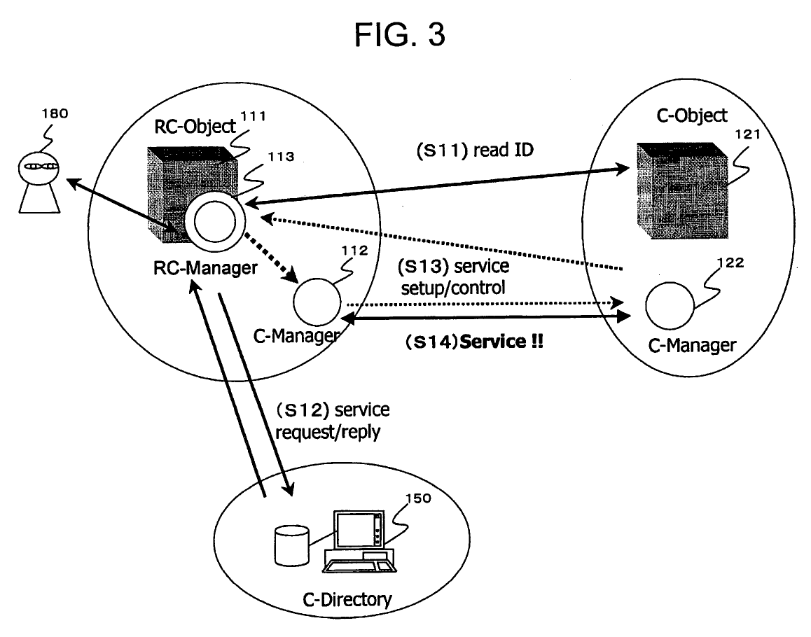

FIG. 3 illustrates a relation and a basic operation among components for implementing services via the Service-Chain. In FIG. 3, a C-Manager 112 manages the ID of a RC-Object 111, and a C-Manager 122 manages the ID of a C-Object 121. The RC-Object 111 is a C-Object having a RC-Manager, and thus has a role as a controller of services.

A RC-Manager 113 arranged on the RC-Object 111 reads the IDs of the respective C-Objects, and requests a C-Directory 150 to find if there is any service implementable using these IDs.

In a configuration shown in FIG. 3, first, in step S11, the RC-Manager 113 reads the ID of the C-Object 121, and makes a service request to the C-Directory 150 in step S12 together with the ID of the C-Object 111 which the RC-Manager 113 itself manages.

The RC-Manager 113 makes the service request to the C-Directory 150 by transmitting the two IDs, which are the ID of the RC-Object Ill and the acquired ID of the C-Object 121, to the C-Directory 150, in order to find any implementable service involving these C-Objects.

Also in step S12, a service reply is returned from the C-Directory 150, which includes a list of available services, and the RC-Manager 113 selects available service(s) therefrom through interaction with a user 180. It should be noted that the service reply from the C-Directory 150 includes C-Manager information corresponding to the respective services listed.

Next, in step S13 of FIG. 3, the RC-Manager 113 specifies the C-Manager 112 managing a service corresponding to the ID of the RC-Object 111 and the C-Manager 121 managing a service corresponding to the ID of the C-Object 121, according to the service reply from the C-Directory 150, and sets up a service for these C-Managers 112 and 132. Following this service setup step, a service involving the C-Objects 111 and 121 is implemented in step S14.

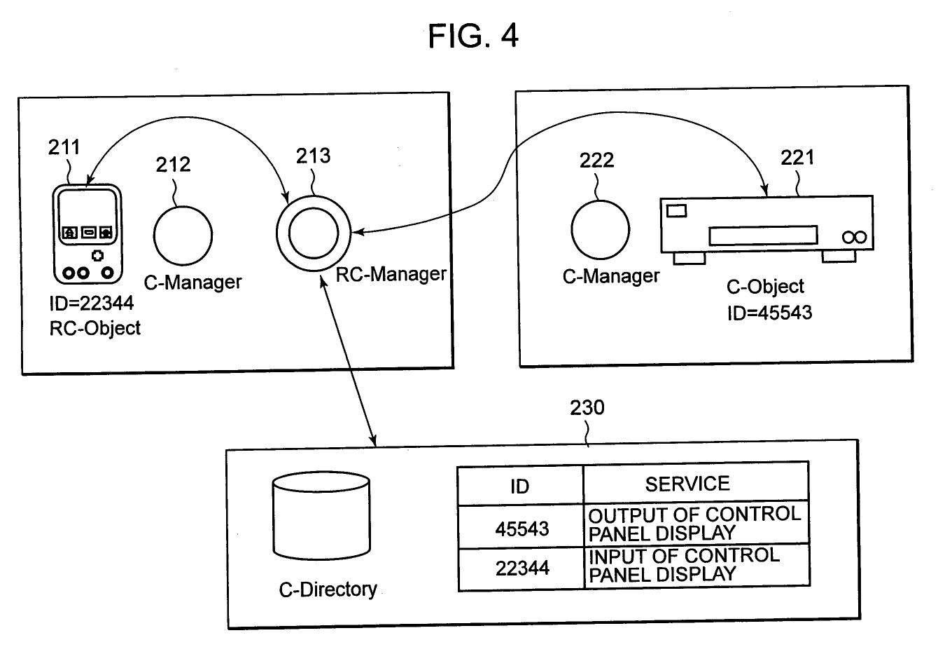

Referring now to FIG. 4, a specific example of a service utilizing the Service-Chain will be described. The exemplary service utilizing the Service-Chain refers to an example in which a PDA 211 controls a video 221. In this example, the video 221 is a C-Object, and the PDA 211 is a RC-Object. They have their own unique IDs.

A RC-Manager 213 checks an ID (=22344) of the PDA 211 to which it belongs, and also gets an ID (=45543) of the video 221 via a communication section such as a Bluetooth or the like.

Next, the RC-Manager 213 transmits both the ID (=22344) of the PDA 211 and the acquired ID (=45543) of the video 221 to a C-Directory 230, to request any service that may be provided by applying these C-Objects.

The C-Directory 230 has a database in which services that maybe implemented by respective C-Objects are registered. In this example, as shown in the figure, a service of “control panel display output” from the video 221 and a service of “control panel display input” to the PDA 211 are registered in association with their respective IDs. Notice is given to the RC-Manager 213 of the PDA 211 that a “control panel display” service is available, as a reply to the request to the C-Directory 230.

The RC-Manager 213 arranged so as to correspond to the PDA 211 notifies a C-Manager 222 of the video 221 and a C-Manager 212 of the PDA 211 that the “control panel display” service will be performed, so that the C-Manager 212 of the PDA 211 can receive the control panel display service from the C-Manager 222 of the video 221 by starting a program such as a Web browser of interest.

In other words, various control buttons such as play, stop, forward, rewind and pose of the video 221 are displayed on a display of the PDA 211, thereby permitting the PDA to be used as a remote controller for the video.

The configuration for these processes can be easily implemented using the existing technology such as, for example, UPnP, Jini and HAVi. However, the Service-Chain does provide more than what is implemented by the existing service infrastructure as described below.

For example, when the PDA 211 becomes available to control the video 221, a nearby projector can additionally be specified as an object for control. The conventional technology such as UPnP, Jini and HAVi allows the PDA to control the projector by similar processes to those mentioned above.

However, when the projector is specified in the Service-Chain, the service of “control panel display input” to the PDA is changed to a service of “control panel display output” from the projector, allowing the PDA to control the projector, and at the same time, matching between a “moving picture (MPEG1) service output” from the video and a “moving picture (MPEG1) service input” to the projector which are registered in the C-Directory 230 is detected, thereby making a new service implementable.

That is, the RC-Manager 213 arranged so as to correspond to the PDA 211 requests the C-Directory 230 to find any service providable by applying three objects, namely, the PDA, the video and the projector as C-Objects, and in response thereto, the C-Directory 230 transmits a list of implementable services involving these three C-Objects (PDA, video and projector) to the RC-Manager 213 arranged so as to correspond to the PDA 211.

The list indicates that a “moving picture play/display” process involving the “moving picture(MPEG) service output” from the video and the “moving picture (MPEG1) service input” to the projector which are registered in the C-Directory 230 is available, and the user who manipulates the PDA 211 can select any implementable process not only from processes involving the PDA and the video or involving the PDA and the projector, but also from processes involving these three objects, namely, the PDA, the video and the projector.

In a service implementing configuration using the Service-Chain according to the present invention, a RC-Manager specifies a plurality of C-Objects to request a C-Directory to find any service implementable by applying the specified C-Objects. The C-Directory extracts data input and/or output information and data processing function information held by each of the specified C-Objects from a database, and sends back implementable service information to the RC-Manager based on these information.

Therefore, a system can be configured in such a way that all of the implementable services using a plurality of C-Objects may be performed.

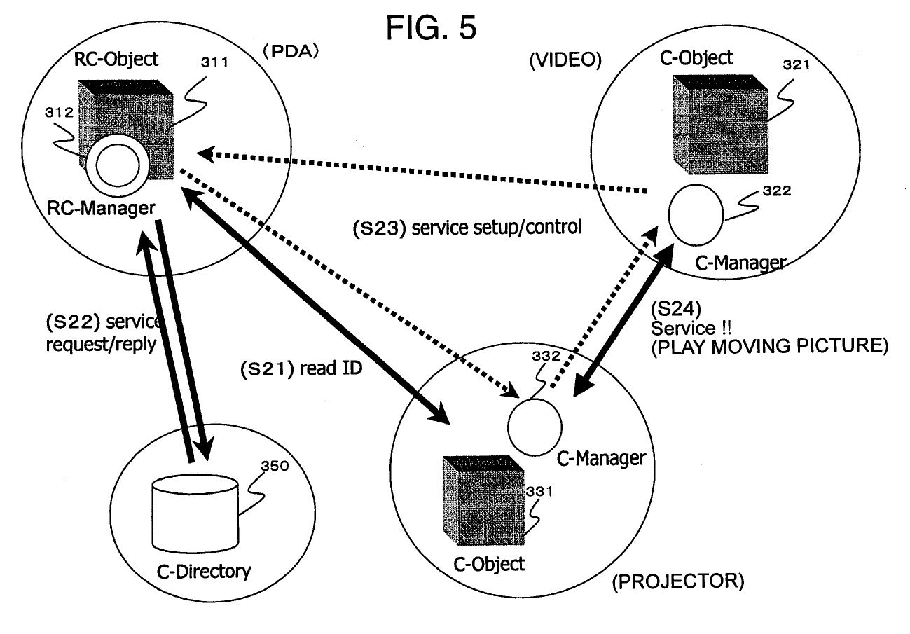

Referring then to FIG. 5, a process will be described which is performed by the video and the projector in order to perform their service, i.e., a moving picture (MPEG1) service process, when the projector is added as anew C-Object.

First, in step S21, a RC-Manager 312, which is arranged so as to correspond to a PDA 311 that serves as a RC-Object, gets the ID of a projector 331 as a C-Object which is a new C-Object, using a special device.

Next, in step S22, the RC-Manager 312 specifies the acquired ID of the projector 331 and the ID of the PDA 311 which is the RC-Object, to request a C-Directory 350 to find any service. Since time information as to this request is within a threshold value in a history of requests made by the RC-Object, the C-Directory 350 transmits to the RC-Manager 312 a list of implementable services involving two arbitrary C-Objects from these three C-Objects, namely, the PDA, the projector and the video.

The list indicates that, in addition to the “control panel display” process by the PDA and the video which is registered in the C-Directory 350, a “moving picture (MPEG1) service” process is also executable, which involves the “moving picture (MPEG1) service output” from the video and the “moving picture (MPEG1) service input” to the projector.

In step S23, according to the service reply received from the C-Directory 350, the RC-Manager 312 specifies a C-Manager 322 managing the video and a C-Manager 332 managing the projector, and sets up a service to these C-Managers 322 and 332. As a result of this service setup step, the “moving picture (MPEG1) service” process involving the “moving picture (MPEG1) service output” from the video and the “moving picture (MPEG1) service input” to the projector is performed in step S24.

2. Basic Technologies in Service-Chain

Next, key technologies will be described as to how the C-Directory recognizes the video and the projector which are individually specified by the PDA, and provides the PDA with a list of usable services, and also as to how data is transmitted from the video to the projector.

Here, abstraction of a service used by the Service-Chain in order to chain one C-Object to another will be described. Additionally, how the C-Directory gives notice about an available service in response to a request from the RC-Manager and how C-Managers actually implement the available service in accordance with that notice will also be described.

(2.1) Abstraction and Chaining of Services

In the Service-Chain, all services provided or received by C-Objects are classified into input {in} services or output {out} services. The attribute of a service is indicated by a data format which an application program that exchanges data can use. By combining C-Objects having input and output services of the same attribute, a service is implemented between the C-Objects.

For example, let it be supposed that there is a C-Object, which is a printer that uses files in a postscript format. This C-Object inputs files in the postscript format. That is, this printer can be chained to all C-Objects outputting files in the postscript format. The Service-Chain has nothing to do with what this C-Object is, be it a camera, a scanner, or whatever apparatus. The printer simply provides printout of inputted files in the postscript format.

Furthermore, single C-Object may have a plurality of services. For example, if the C-Object itself has a program for converting a file in a JPEG format into a file in the postscript format, then a JPEG input service can additionally be listed as a service for that C-Object.

It should be noted that file format notations need some common rule. For example, a file format notation defined by a MIME type may be used. A postscript file is notated as application/postscript in the MIME notation.

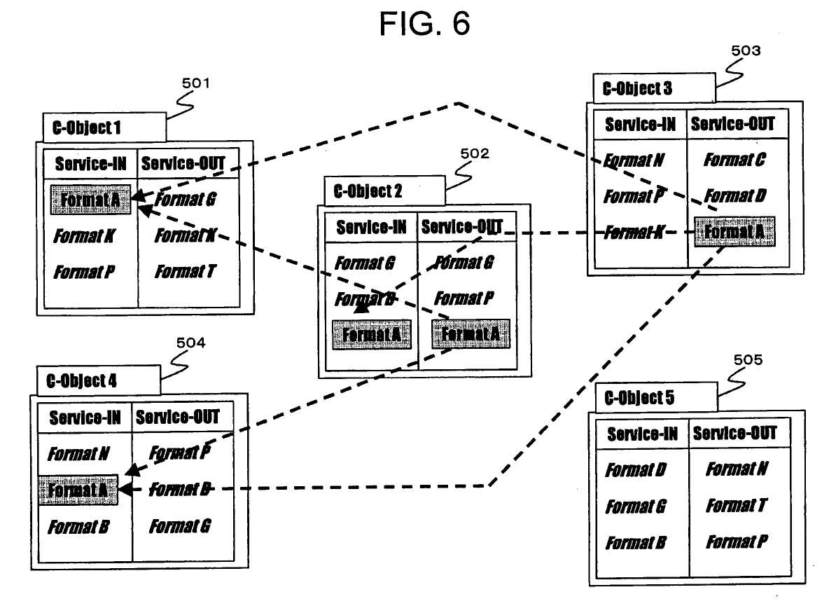

FIG. 6 shows a conceptual diagram showing file formats of {input} or {output} that may be executed by a plurality of C-Objects and their matching relation. In FIG. 6, there are five C-Objects, each of which has input and output services. Their service names are given by their formats. Assuming that a C-Object 1,501 is a RC-Object, then the C-Object 1,501 has a Format A as a file format possible for input, and can perform a data input/output service in the format A with each of C-Objects 2,502 and 3,503 having the Format A as their file format possible for output.

All file format information of {input} or {output} that may be executed by a plurality of C-Objects shown in FIG. 6 are registered in a C-Directory.

The C-Directory, upon receiving a service query in which the IDs of C-Objects are specified from a RC-Manager, performs a matching process to search a data input/output service executable by the C-Objects specified in term of the file format information, and transmits service information that can be provided in the matched combination to the RC-Manager as its reply to the service query.

(2.2) Service Providing System by Directory Service

In the Service-Chain, a C-Directory plays the role of directory service. A RC-Manager having acquired the ID of a C-Object in one way or another makes a request to the C-Directory with the ID of its RC-Object.

(2.2.a) ID Acquisition

How the ID of a C-Object is acquired is not specified in the Service-Chain. Techniques such as by infrared communication and rfID may be employed in order to read the ID. A new function may also be added such as by deriving the ID from a service name.

It should be noted that the entity of C-Objects are such that they need not be connected to a network individually. For example, there are 100 music CDs, and each music CD is treated as a C-Object with an ID thereof given individually.

Specifying a PDA, which a user can manipulate, as a RC-Object having a RC-Manager, the PDA is caused to read the ID of a user's favorite CD. When the ID of the PDA and the ID of the CD are then sent to the C-Directory, the C-Directory sends back to the RC-Manager, or the PDA in this case, a service list, whereby the user can display the service list on a display of the PDA. The service list defines available services, such as a service for performing a music streams forwarding/playback process for music stored in the music CD after connecting a server distributing the music streams of the music CD to a music playing application in, for example, a Real media format, and a service for displaying music information in the HTML data on the display of the PDA after connecting a Web server transmitting music information in a HTML format to a Web browser.

In this case, it is the server distributing the music streams and the Web server transmitting the music information in HTML format that manage the IDs of the 100 CDs. The data is not provided directly from the music CDs themselves. That is, apparatus providing service can be deemed as a separate entity from ID-given C-Objects. In such a framework, any material in the real world could be deemed as a symbol of service.

It should be noted that as a technique of acquiring the ID of a C-Object, for example, a real world-oriented interface may be employed, which is disclosed by J. Rekimoto (“The World through the Computer: Computer Augmented Interaction with Real World Environments”, In proceedings of ACM Symposium on User Interface Software and Technology, Virtual and Augmented Realities (UIST '95), November 1995).

(2.2.b) History-Based Service Provision

It is, without exception, two IDs that a RC-Manager transmits to a C-Directory for a service request. The first one is the ID of the RC-Object itself, and the second one is the acquired ID of another C-Object. The RC-Manager makes a service request to the C-Directory every time it reads a new ID.

Therefore, when querying the C-Directory about an implementable service involving, for example, the RC-Object itself and other two C-Objects, the RC-Manager makes a request to the C-Directory twice.

When querying the C-Directory about an implementable service involving the RC-Object itself and other n C-Objects, the RC-Manager makes a service request to the C-Directory n times.

The C-Directory having received the service request from the RC-Manager checks if any service is available which can be provided in combination of the two IDs contained in the request, and simultaneously therewith, has a request message reception time and the two IDs contained in the request, i.e., the requester's ID (the ID of the RC-Object) and the ID of another C-Object, as a Chain-List.

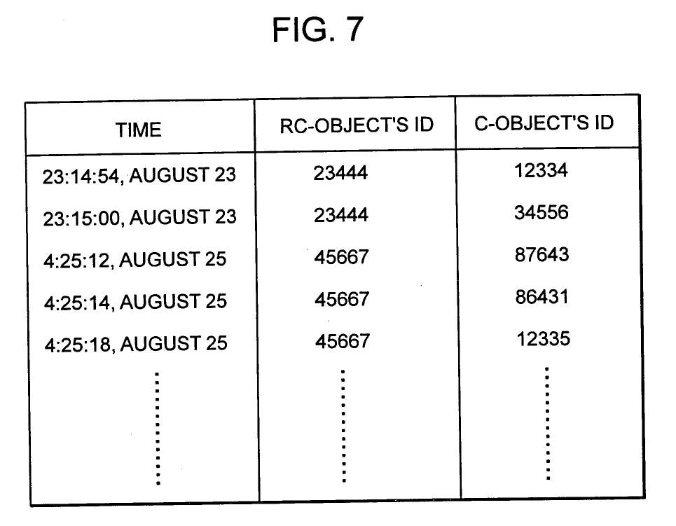

The Chain-List is a history of service requests made by the RC-Manager. An example of the Chain-List is shown in FIG. 7. As shown in FIG. 7, the Chain-List has data that corresponds the request message reception time to the two IDs contained in a request, i.e., the ID of a requester (the ID of a RC-Object) and the ID of another C-Object.

The C-Directory references the Chain-List, without fail, whenever it receives a service request from the RC-Manager to judge whether or not service requests are successively made. The reason why the request reception times are recorded is to differentiate the processing of a request after a long interval from that of a request after a short interval.

When receiving requests each containing a combination of the ID of the common RC-Object and the ID of a different C-Object within a predetermined threshold time, the C-Directory judges that the service requests are successively made, and thus extracts information about services providable by the combination of the RC-Object and the C-Object not only in the current request but also in the preceding request(s), and transmits the extracted information as replies.

That is, assuming that the ID of the RC-Object is ID-r and the IDs of other C-Objects are ID-a1, ID-a2, ID-a3 and so on, and that the C-Directory receives a service request in a combination of {ID-r, ID-a1}, another service request in a combination of {ID-r, ID-a2} and still another service request in a combination of {ID-r, ID-a3} in succession within a threshold time, it first transmits service information providable in the combination of {ID-r, ID-a1} as a reply to the service request in the combination of {ID-r, ID-al} as a reply. Further, in response to the service request in the combination of {ID-r, ID-a2}, the C-Directory transmits not only service information providable in the combination of {ID-r, ID-a2} but also service information providable in combinations of {ID-r, ID-a1} and {ID-a1, ID-a2}.

In response to the service request in the combination of {ID-r, ID-a3}, the C-Directory transmits service information providable in any possible combinations among ID-r, ID-a1, ID-a2 and ID-a3 as a reply.

On the other hand, upon receiving requests of combinations of the ID of the same RC-Object with the ID(s) of other different C-Object(s) within a time exceeding the predetermined threshold time, the C-Directory judges that the requests are not successive, and transmits only information about service(s) providable in an ID combination of the RC-Manager and a different C-Object contained in each request of interest excluding any combinations in the preceding request(s), as a reply to that request.

In processing, the C-Directly searches combinations of implementable services involving all the C-Objects corresponding to the IDs contained in the Chain-List, and provides the search result in the form of a list, when receiving from the same RC-Object service requests in which the IDs of different C-objects are combined within the threshold time.

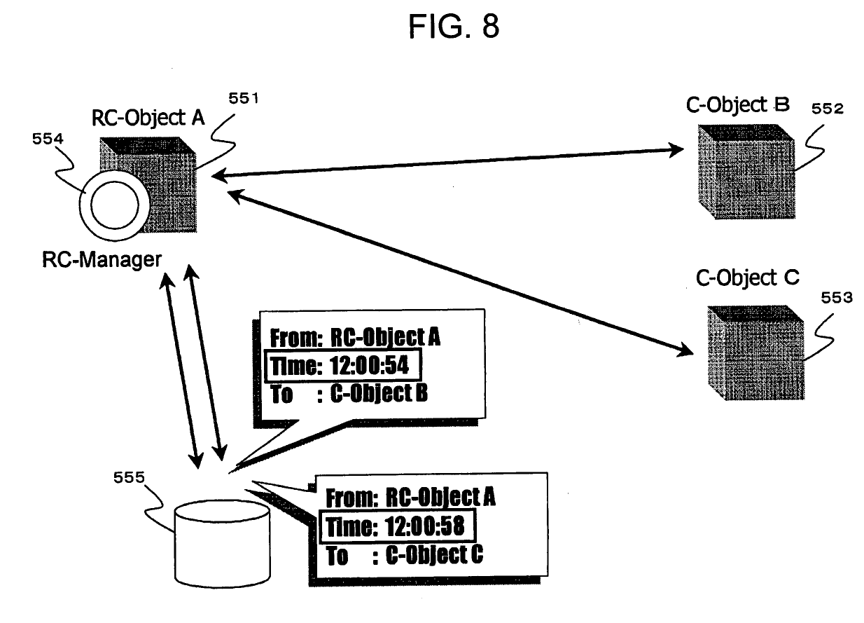

FIG. 8 shows an exemplary process in which a RC-Manager 554 of a RC-Object A 551 makes a service request based on a combination thereof with a C-Object B 552 and a service request based on a combination thereof with a C-Object C 553 successively to a C-Directory 555.

When the C-Directory 555 receives the service request based on the combination with the C-Object C 553 from the RC-Manager 554 of the RC-Object A 551 at a time {12:00:58}, it determines whether or not there has been another service request from the same RC-Object A 551 within the threshold time by a search throughout the Chain-List.

In the Chain-List, request information as of a time {12:00:54} is recorded, and the C-Directory thus generates a list of implementable services considering not only the combination of the RC-Object A 551 with the C-Object C 553, but also its combination with the C-Object B 552 contained in the request information as of the time {12:00:54} recorded in the Chain-List.

The C-Directory generates service information including all services implementable in the combinations of the RC-Object A 551 with the C-Object B 552 and with the C-Object C 553, and transmits a reply to the service requests to the RC-Manager 554 of the RC-Object A 551. It would be preferable to set the threshold time in the C-Directory appropriately in consideration of communication packet forwarding traffic in a network involved. For example, the threshold time may be set at approximately between 5 to 10 seconds.

(2.3) Chain-Manager (C-Manager)

The RC-Manager can learn about the providable service information based on the reply to the request received from the C-Directory. Based on this reply, the RC-Manager passes that information to each C-Object involved in some way, in order to cause that C-Object to perform an application program for performing the service, i.e., an application program for performing data processing executable by each C-Object, such as, for example, reproduction and output of moving picture data, or transmission of music data.

However, to design an application of each C-Object so as to be directly compatible with information from the RC-Manager would impair the degree of freedom in developing the application in a manner dedicated to the data processing scheme of the apparatus. In order to overcome this inconvenience, the system of the present invention introduces a C-Manager that acts as an intermediary for the information in order to secure the independence of each application performed in the Service-Chain. In the following, the C-Manager will be described in detail.

(2.3.a) Chain-Tokens

Chain-Tokens are used for communication between the RC-Manager of a RC-Object and a C-Manager, and between C-Managers.

The Chain-Tokens are sent from the RC-Manager to a C-Manager at which a destination routing process is performed, and finally returned to the RC-Manager, without exception.

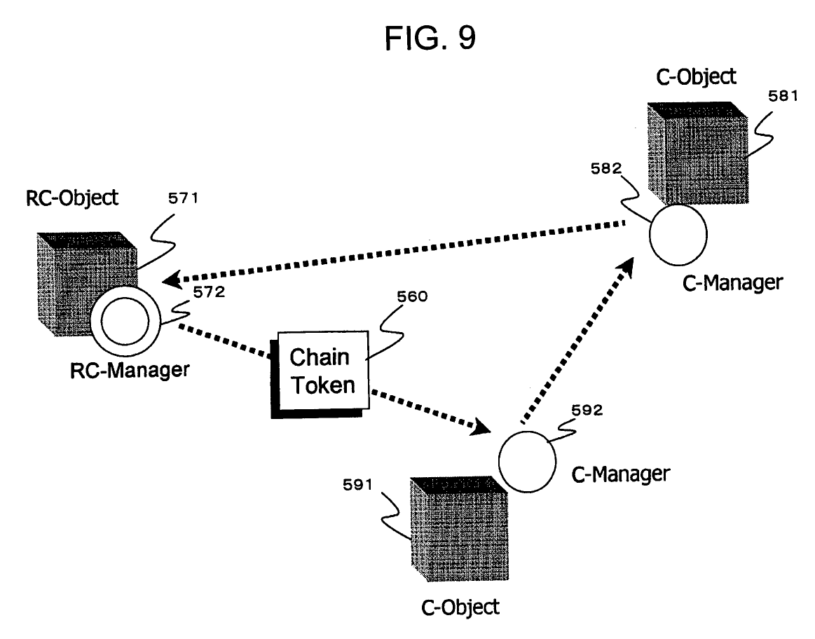

Referring now to FIG. 9, a process of forwarding a Chain-Token will be described. In an example of FIG. 9, a RC-Manager 572 of a RC-Object 571 forwards a Chain-Token 560 when performing a service involving two C-Objects 581 and 591 other than itself.

If some information is needed from the user regarding the implementation of the service, the Chain-Token 560 can be used to deliver the information to each C-Manager. The Chain-Token is used to exchange information necessary for performing programs between C-Managers and to perform control, such as start and end of the service.

(2.3.b) Start and End of Service

From when the RC-Manager determines a service for implementation to when the service is actually started, a Chain-Token is transmitted twice. A first Chain-Token is sent to get information necessary for implementing the service, i.e., to cause the RC-Manager to make a request for necessary information to other C-Managers or to the user. A second Chain-Token is used as a start requesting message for actually starting the service. For a service not particularly requiring a request, only the start requesting Chain-Token is used, without sending the information requesting token.

Each C-Manager has a table in which the IDs of the C-Objects are associated with corresponding programs executable by the respective C-Objects. The C-Manager also manages information necessary for performing the respective program. For example, in order to perform a Web browser program, information such as a URL is necessary, and thus the C-Manager arranged so as to correspond to the C-Object performing the Web program will have the URL information as the information necessary for performing the Web browser program which is the executable program.

The C-Manager having received the first Chain-Token stores (attribute) and (value) in respective fields in the Chain-Token as program information necessary for performing a program for implementing a specified service, and returns it to the RC-Manager or forwards it to other C-Managers. If the C-Manager fails to set the initial information, then it leaves the field(s) empty. Further, the C-Manager stores information as to whether the application is proactively (in active manner) started or reactively (in passive manner) started.

It should be noted that a connection such as TCP abides by a rule that a reactive program must precede a proactive program, and thus that these information are used to determine the order in which to send the second Chain-Token to the C-Manager(s) involved.

When the first Chain-Token is returned, the RC-Manager determines and inputs a value if there is any empty attribute field, through its interaction with the user via the user interface. Or, if, for example, there is any discrepancy between information specified by the two C-Managers, the discrepancy is mediated if the mediation is possible. At the time of transmitting the second Chain-Token, destination routing is performed by addressing first a C-Manager having a program that starts the service reactively.

The C-Manager having received the second Chain-Token gets the information necessary for starting the program from the Chain-Token as necessary, and starts the program corresponding to the service. In order to control the started program, the C-Manager has process information of the program being performed, making executable various control such as forced termination of the program, using the Chain-Token from the RC-Manager as a trigger.

A specific configuration of the Chain-Token and processes using the Chain-Token will be described later.

3. Implementation of Service-Chain

The previous section discussed some key technologies of the Service-Chain. While there is a variety of ways of integrating these technologies for operation, the present section presents some examples of configurations with minimal functionality in the Service-Chain. Processing involved in the Service-Chain can be divided roughly into two processes.

A first process relates to service requests from a RC-Manager to a C-Directory and replies to the requests. A second process involves the RC-Manager requesting a C-Manager, in response to a service list, to perform a service, the C-Manager being arranged so as to correspond to a C-Object necessary for performing the service.

(3.1) Registration of Service Profiles

When adding a new C-Object as an element of the Service-Chain, a service profile of that C-Object must be registered in a C-Manager and a C-Directory. A process of registering the service profile will be described.

The following seven items are included in a service profile to be registered in the C-Manager.

(1) Identifier (ID)

(2) Service name

(3) Input or output

(4) Proactive or reactive

(5) Usage of program path and argument

(6) Attribute of argument

(7) Value

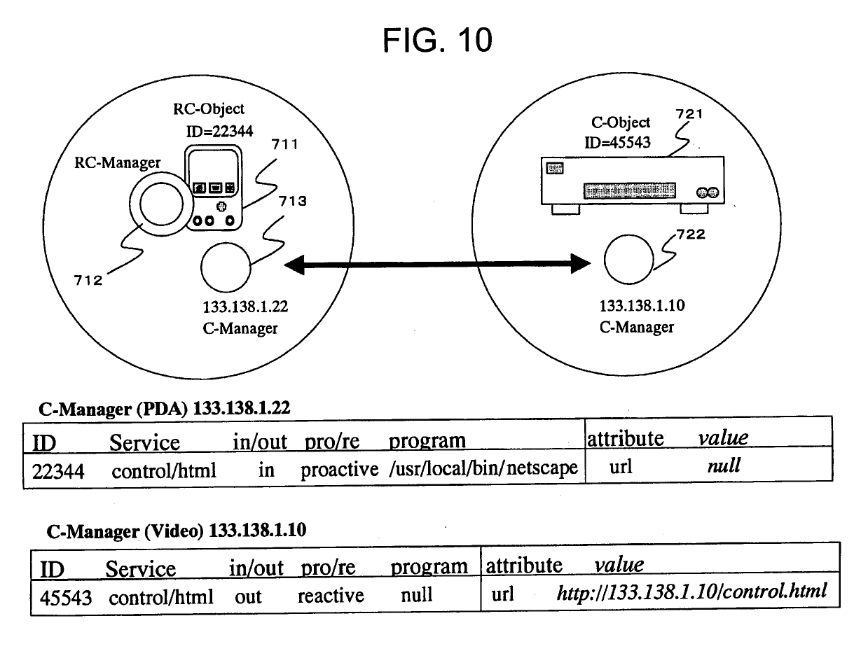

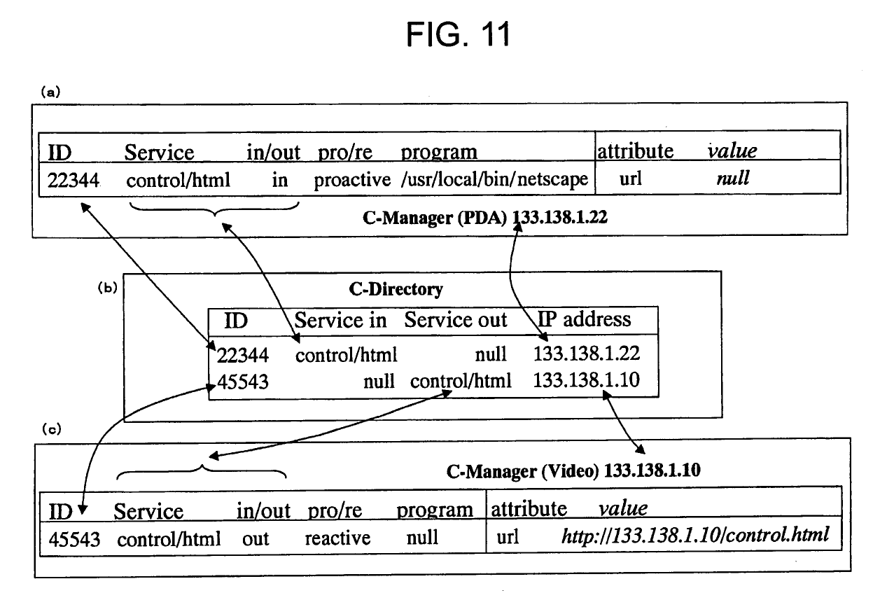

Exemplary configurations of service profile data to be registered in C-Managers are shown in FIG. 10. An example of FIG. 10 refers to a service for performing control panel display in HTML on a PDA 711 so as to allow the PDA 711 to control a video 721. Additionally, a correspondence relation between a service profile of each C-Manager and service information held by the C-Directory is shown in FIG. 11.

(1) “ID” is an identifier set on a C-Object corresponding to a C-Manager. In the example of FIG. 10, an ID=22344 set on the PDA 711 as a C-Object is entered in the service profile of a C-Manager 713 corresponding to the PDA 711 as the C-Object, and an ID=45543 set on the video 721 as a C-Object is entered in the service profile of a C-Manager 722 corresponding to the video 721 as the C-Object.

(2) “Service name” is a name given to an individual service. In the example of FIG. 10, a service name {control/html} indicating that a control panel display service for performing “control panel display” of the video in HTML on a display of the PDA is stored in both the service profile of the C-Manager 713 corresponding to the PDA 711 and the service profile of the C-Manager 722 corresponding to the video 721.

(3) “Input or output” is information indicating that a data processing format executable by a C-Object corresponding to a C-Manager is either {in} for input or {out} for output. In the example of FIG. 10, the PDA 711 is responsible for performing an input process for the “control panel display” in HTML, and thus {in} is set in the service profile of the C-Manager 713 corresponding to the PDA 711 responsible for HTML data input, whereas the video 721 responsible for HTML data output performs an output process for the “control panel display” from the video, and thus {out} is set in the service profile of the C-Manager 722 corresponding to the video 721.

Each of these information, i.e., (1) “ID”, (2) “Service name” and (3) “Input or output”, is also stored in the C-Directory as shown in FIG. 11, as the corresponding service information for each of its C-Objects listed.

(4) “Proactive or reactive” refers to whether or not an application performed in a C-Object starts proactively or reactively. In the example of FIG. 10, a processing application using control panel display data of the video, i.e., control of the video 721 is proactively performed by the PDA 711, and thus it is the video 721 that is controlled, making the video reactive. Therefore, {proactive} is set in the service profile of the C-Manager 713 corresponding to the PDA 711, whereas {reactive} is set in the service profile of the C-Manager 722 corresponding to the video 721.

(5) “Usage of program path and argument” is used to specify how program path and argument necessary for performing a service are used. For example, to register a file get processing program {file get} as a program requiring a port number and an address as arguments, a statement {/usr/local/bin/fileget-p $port-ip $address} is written. In this case, (6) “Attribute of argument” involves two items {port} and {address}.

In the example of FIG. 10, {/usr/local/bin/netscape} is set in a field (program) of how the program path and argument of service profile of the C-Manager 713 corresponding to the PDA 711 are used to perform the “control panel display” of the video in HTML on the display of the PDA, and information {url} is entered in the field (attribute) or (6) “Attribute of argument”. On the other hand, the video 721 performs a reactive process, and thus {null} is set in the field (program) of the service profile of the C-Manager 722, and only attribute information {url} is stored in the field (attribute) or (6) “Attribute of argument”.

(7) “Value” is a value corresponding to an attribute set to perform a program corresponding to a service. In the example of FIG. 10, in order to perform the “control panel display” of the video in HTML on the display of the PDA, the value of the url is set in a field (value) of the service profile of the C-Manager 722 of the video 721.

For example, the following attribute-value correspondence may be used.

| Attribute | Value |
|---|---|
| url | URL address |
| protocol | Protocol |
| port | Port number |
| ipaddress | IP address |
| macaddress | MAC address |

It would be necessary to pre-define these attribute names.

The following four items are registered in the C-Directory as shown in FIG. 11.

(1) ID of C-Object

(2) List of input service names (Service in)

(3) List of output service names (Service out)

(4) IP address of C-Manager

Of the above four items, the three excluding the IP address are information corresponding to the information registered in the service profile of each C-Manager as mentioned above.

In a mode where the C-Manager notifies the C-Directory about the registered information, the C-Directory can learn of the IP address of the C-Manager, and thus all the above four items can be acquired from the registered information in the C-Manager.

In the Service-Chain, service profiles must be registered in C-Managers manually. On the other hand, there could be a plurality of C-Directories over the network. The service profiles may be updated from time to time, as a new C-Object is added to the Service-Chain or anew application is introduced into a registered C-Object, for example. Thus, it would be difficult to manually update all these information. A process of registering service profiles will be described below.

(1) A user registers a service profile of a C-Object he or she wishes to newly add as an element of the Service-Chain, in a database of the C-Manager.

(2) When the service profile database held by the C-Manager is updated, the updated time and service profile information held are multicast over a network.

(3) AC-Directory having received the multicast service profile information updates the corresponding service profile of the registered C-Object.

Further, in the Service-Chain, a RC-Manager discovers a C-Directory, or prepares a protocol for receiving existing service profile information from a C-Manager when a new C-Directory is added to the network to perform transfer of the information according to this protocol. Further, when a RC-Manager having read the ID of a C-Object does not know a C-Directory registering service information corresponding to the ID of the C-Object, the Service-Chain multicasts a request packet for discovering a C-Directory. All C-Directories that have received this packet must respond.

As to the IDs of C-Objects participating in the Service-Chain, their service information is registered in at least one C-Directory, and a RC-Manager making a request to the C-Directory based on these IDs can get the service information of the C-Objects corresponding to the request from that C-Directory.

Furthermore, when a C-Directory newly participates in the network, it can transmit a service profile requesting packet. All C-Managers that have received this packet transmit a packet to the requesting C-Directory as their replies, the packet storing the items (see FIG. 11) of their profile data to be registered in the C-Directory. As a result of these replies, the requesting C-Directory can get service profile information available within the network.

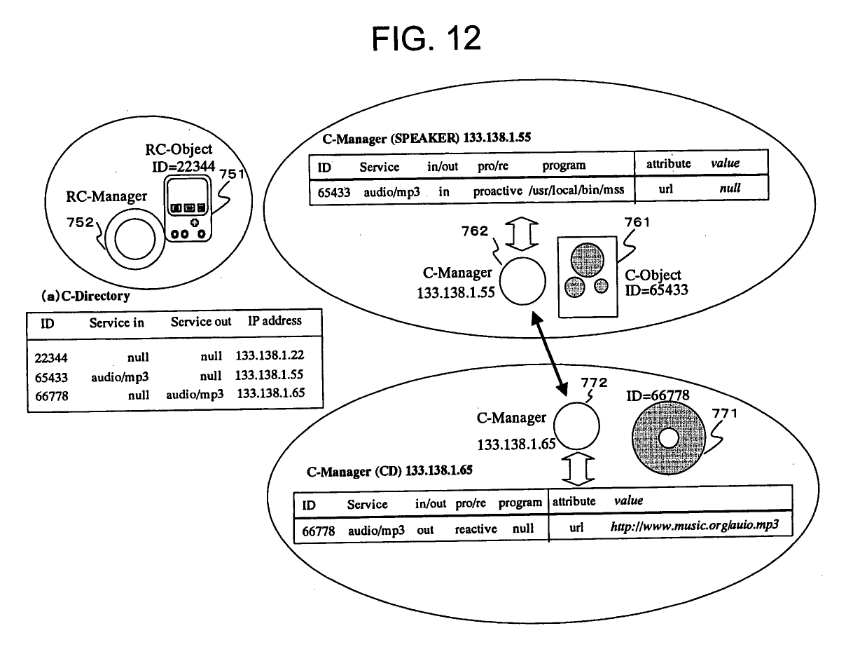

FIG. 12 shows exemplary service profile data registered in each C-Manager and service information/data of a C-Directory, in a service execution mode in which a RC-Manager 752 corresponding to a PDA 751 as a C-Object gets C-Objects' IDs from a C-Manager 762 corresponding to speakers 761 as a C-Object and a C-Manager 772 corresponding to a CD 771 as a C-Object to make a service request to the C-Directory, and performs a content reproducing process of the CD 771 using the speakers 761.

In the service profile of the C-Manager 762 corresponding to the speakers 761, an ID=65433 of the speakers 761 as the C-Object is registered as the ID; {audio/mp3} indicative of an mp3 audio data format is registered as the service name; and {in} is set as the data processing format since it involves mp3 audio data input.

Also, as information about whether an application performed in the C-Object starts proactively or reactively, (proactive) is set in the service profile of the C-Manager 762 corresponding to the speakers 761 since a configuration is envisaged in which music data is distributed and played based on a music playing request from the speakers 761; and in the field (program) or Usage of program path and argument, {/usr/local/bin/mss} is set; and further, {url} is stored in the field (attribute) or Attribute of argument.

On the other hand, in the service profile of the C-Manager 772 corresponding to the CD 771, an ID=66778 of the CD 771 as the C-Object is registered as the ID; {audio/mp3} indicative of the mp3 audio data format is registered as the service name; and {out} is set as the data processing format since it involves mp3 audio data output.

Also, as information about whether an application performed in the C-Object starts proactively or reactively, {reactive} is set in the service profile since the music data is distributed based on the music playing request from the speakers 761; in the field (program) or Usage of program path and argument, {null} is set since the program is performed reactively; further, {url} is stored in the field (attribute) or Attribute of argument; and a value of the url for performing the distribution of the mp3 audio data is set in the field (value).

(3.2) Service Request and Reply

The RC-Manager of a RC-Object must read the ID(s) of other C-Object(s). No method of reading the IDs is specified in the Service-Chain. As mentioned above, any object is supposed to be a C-Object in the Service-Chain. Since it is a C-Manager that actually provides a service of a C-Object, the C-Object does not need to have a communication device attached thereto. The ID of a C-Object can be acquired by techniques such as via infrared, bar code, rfID and the like, besides via a network. One could also utilize the above-mentioned real world-oriented interface, such as connecting objects together, or sensing the ID of a C-Object by capture using a camera, to improve convenience.

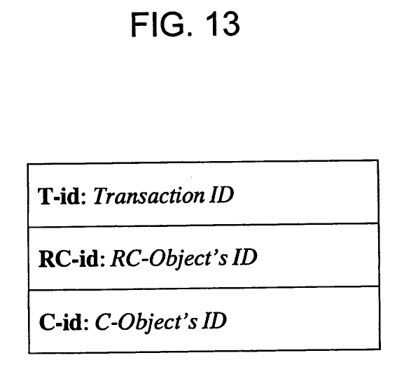

FIG. 13 shows a service request frame format for transmission from a RC-Manager having sensed the ID of a C-Object to a C-Directory. This is a frame used in the application layer. IP and UDP communication protocols are used at the lower layers.

{T-id: Transaction ID} stores random numbers for identifying a reply to a frame having made a service request. {RC-id: RC-Object's ID} and {C-id: C-Object's ID} are two object IDs stored in the service request, which are the ID of a RC-Object and the ID of a C-Object, respectively.

A RC-Manager makes a service request to a C-Directory by transmitting the service request frame shown in FIG. 13 in which the IDs of two C-Objects are stored. Note that service information for execution in two or more combinations of C-Objects can be acquired by transmitting frames having stored the IDs of different C-Objects in succession within a predetermined threshold time, as mentioned above.

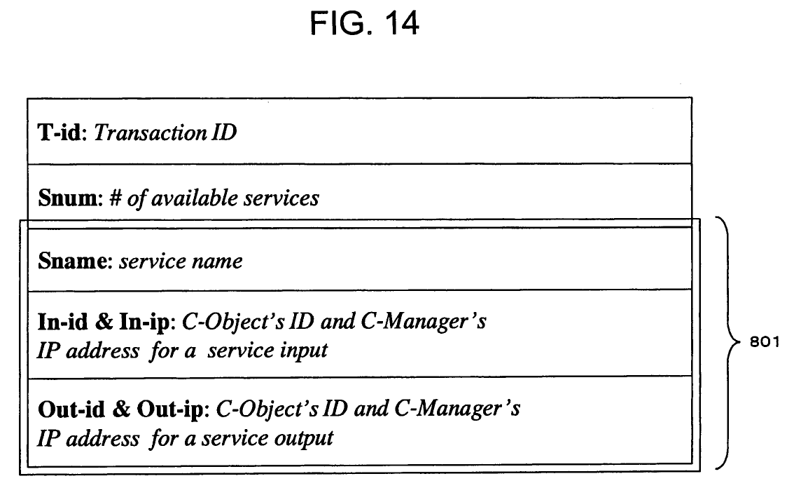

FIG. 14 shows a service request reply frame format for transmission to a RC-Manager by a C-Directory that has received the service request frame shown in FIG. 13 from the RC-Manager.

{T-id: Transaction ID} directly stores what is stored as {T-id:transactionID} of the service request frame. {Snum: Number of available services} stores information indicative of the number of services judged to be implementable by the C-Directory.

Below these items is an area 801 where specific service information is stored. Information in the area 801 pertains to a single service. If a plurality of services are available, a plurality of information sets each of which corresponds to the area 801, i.e., the number of sets corresponding to the number of available services in the field (Snum) are added. For example, when Snum=3, 3 sets of service areas follow below the field (Snum).

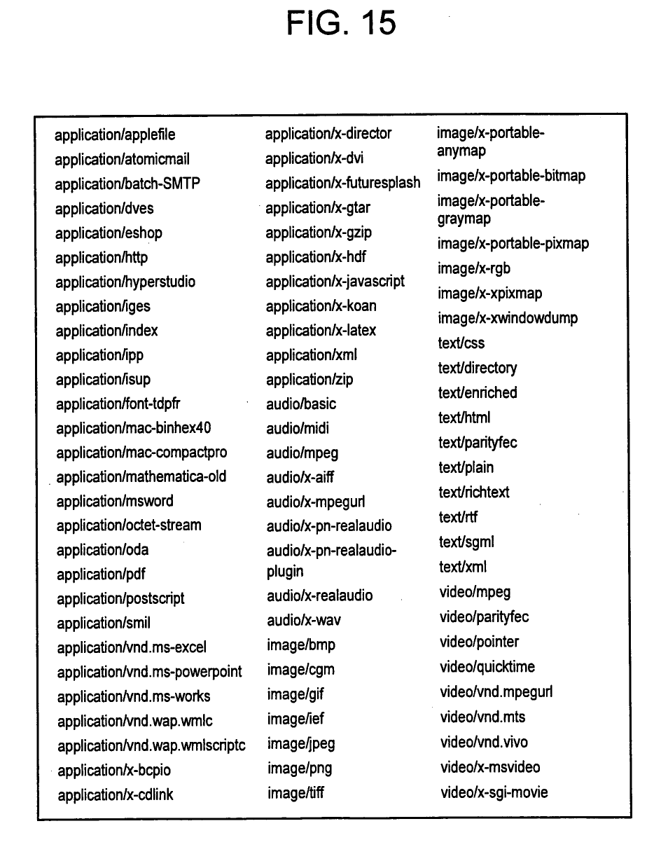

{Sname: Service name} stores the name of a service. A service is denoted as {type/subtype} such as text/html, or control/html, application/EDI-Constant, audio/mp4a-latm, image/jpeg or the like. Thus, any MIME notation could be entered directly. Further, in order to allow the user to select an available service from a service name, this notation is converted into a character string intelligible by the user whenever necessary for presentation to the user. This conversion process is performed by the RC-Manager whenever necessary. Examples of MIME file formats applicable to the configuration of the present invention is shown in FIG. 15.

{(In-id & In-ip): C-Object's ID and C-Manager's IP address for a service input} stores the ID of a C-Object and the IP address of a C-Manager implementing a service input.

{(Out-id & Out-ip): C-Object's ID and C-Manager's IP address for a service output} stores the ID of a C-Object and the IPaddress of a C-Manager implementing a service output.

(3.3) Request for Service Attribute and Chaining of Services

The RC-Manager having received the service request reply frame shown in FIG. 14 from the C-Directory must select one desired service from plural services, if such plural services are listed.

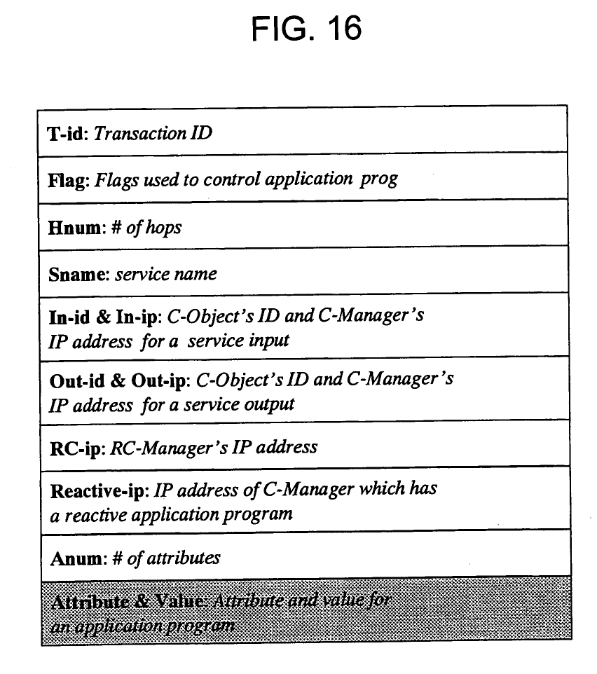

The selection is made by interaction between the RC-Manager and the user. When a desired service is determined, the RC-Manager creates a Chain-Token in a format of FIG. 16.

{T-id: Transaction ID} stores a transaction ID which is the identifier of a Chain-Token frame.

{Flag: Flag used to control an application program} stores a flag indicating to a C-Manager the type of a control message, such as start or end of an application.

{Hnum: Number of hops} stores the number of hops in a Chain-Token} frame. The C-Manager can learn about how many times the Chain-Token is transmitted, and determines its next destination, based on the number of hops.

{Sname: Service name} stores the name of a selected service.

{In-id & In-ip: C-Object's ID and C-Manager's IP address for a service input} stores the ID of a C-Object and the IP address of a C-Manager implementing a service input.

{Out-id & Out-ip: C-Object's ID and C-Manager's IP address for a service output} stores the ID of a C-Object and the IP address of a C-Manager implementing a service output.

The information stored in the service request reply frame received from the C-Directory shown in FIG. 14 are stored in these fields (In-id & In-ip) and (Out-id & Out-ip).

{RC-ip: RC-Manager's IP address} stores the IP address of the RC-Manager itself.

{Reactive-ip: Ip address of C-Manager which has a reactive application program} stores the IP address of a C-Manager which has a reactively starting application. While the Chain-Token is being circulated for the first time, a C-Manager that is found on its way stores a value in this field. Thus, the RC-Manager initially sends the Chain-Token leaving this field empty.

{Anum: Number of attributes} and {Attribute & Value: Attribute and value for an application program} store the number of attributes, and an attribute and a value corresponding to a service performing program, respectively. These items are not entered when the Chain-Token is initially transmitted, but will be entered by a C-Manager found on the way through its transmission.

As mentioned above, the Chain-Token is transmitted to the C-Manager responsible for a service input. The C-Manager has a program corresponding to a service associated with the ID of a C-Object it manages, and an attribute {Attribute} and a value {Value} necessary for performing that program. The C-Manager responsible for a service input stores its attribute {Attribute} and value {Value} in the Chain-Token. Note that the Chain-Token is transmitted with nothing written as {Value} if no default is available.

It should be noted that {Anum: Number of attributes} indicates the number of attributes {Attribute}, and there will be as many sets of {Attribute} and {Value} as the number set as {Anum: Number of attributes). A necessary value {Value} is inputted via interaction with the user only if there is any attribute the value of which is not yet determined when the Chain-Token has returned to the RC-Manager.

When the RC-Manager transmits a second Chain-Token, that Chain-Token is transmitted first to a C-Manager performing a reactive program indicated as {Reactive-ip}.

The C-Manager having received the second Chain-Token reads from the Chain-Token the attribute {Attribute} and the value {Value} necessary for performing the program and then starts the program for the service.

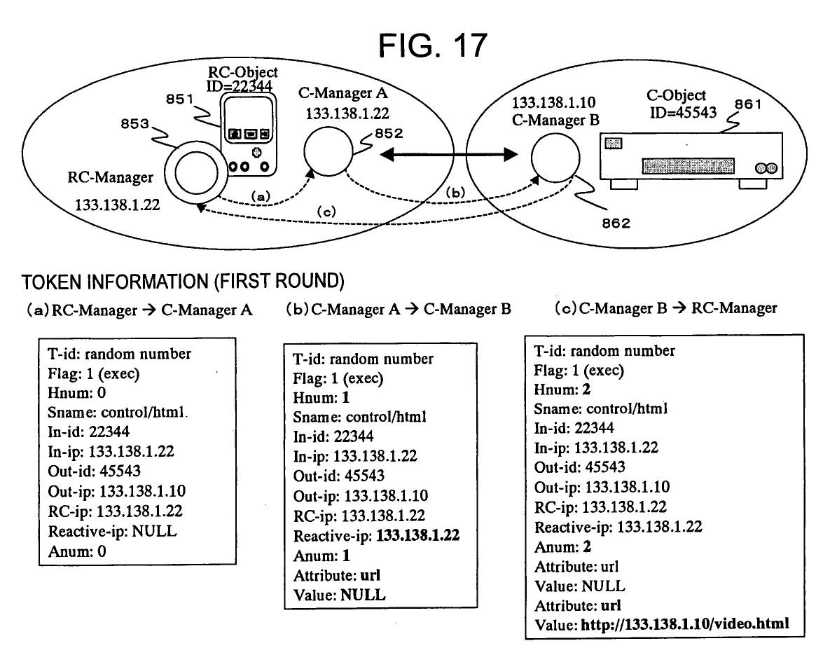

Referring to FIG. 17, a configuration of a Chain-Token corresponding to execution of a specific service and a process using the Chain-Token will be described. An example shown in FIG. 17 is a service for performing control panel display in HTML on a PDA 851 so that the PDA 851 as a RC-Object can control a video 861 as a C-Object.

As mentioned above, from when the RC-Manager has determined a service for implementation to when the service is actually started, two Chain-Tokens are transmitted in principle. The first one is a Chain-Token for information acquisition processing through which the RC-Manager gets information necessary for implementing the service, and the second one is a token used as a start requesting message for actually starting the service. FIG. 17 shows data configurations of a Chain-Token, involved from transmission of a first Chain-Token by a RC-Manager 853 corresponding to the PDA 851 as the RC-Object to its return to the RC-Manager 853 via a C-Manager 852 corresponding to the PDA 851 and a C-Manager 862 corresponding to the video 861.

In FIG. 17, a part (a) shows a data configuration of a Chain-Token transmitted from the RC-Manager 853 corresponding to the PDA 8.51 to the C-Manager 852 corresponding to the PDA 851.

{T-id: Transaction ID} stores random numbers as a transaction ID which is the identifier of a Chain-Token frame. {Flag: Flag used to control an application program} is a flag indicating, to a C-Manager, the type of a control message such as start or end of an application. In this case, it is a first Chain-Token, and thus an identifier flag {1(exec)} is set which indicates that it is a first Chain-Token and thus a Chain-Token for information acquisition processing.

{Hnum: Number of hops} stores the number of hops of a Chain-Token frame. The number of hops=0 is set at this time. {Sname: Service name} stores the name of a service selected. Here, the service name {control/html} indicating a service for performing control panel display in HTML on the PDA 851 is stored.

{In-id & In-ip: C-Object's ID and C-Manager's IP address for a service input} are the ID of a C-Object and the IP address of a C-Manager performing a service input, and an ID=22344 of the PDA 851 as the C-Object and an IP address=133.138.1.22 of the C-Manager 852 corresponding to the PDA 851 performing an input process for control panel display are stored.

{Out-id & Out-ip: C-Object's ID and C-Manager's IP address for a service output} are the ID of a C-Object and the IP address of a C-Manager performing a service output, and an ID=45543 of the PDA 861 as the C-Object and an IP address=133.138.1.10 of the C-Manager 862 corresponding to the video 861 performing an output process for control panel display are stored.

These {In-id & In-ip} and {Out-id & Out-ip} use information contained in the service request reply frame received from the C-Directory shown in FIG. 14, as mentioned above.

{RC-ip: RC-Manager's IP address} stores the IP address=133.138.1.22 of the RC-Manager 853 itself.

{Reactive-ip: IP address of C-Manager which has a reactive application program} stores the IP address of a C-Manager which has a reactively starting application. While the first Chain-Token is being circulated, a value to be entered in this field is stored by a C-Manager encountered on the way of its circulation. {Anum: Number of attributes} is similarly empty at this time.

A part (b) of FIG. 17 shows a data configuration of the Chain-Token transmitted to the C-Manager 862 corresponding to the video 861 from the C-Manager 852 corresponding to the PDA 851.

The part (b) shows a result of a data storage and updating process performed on the Chain-Token by the C-Manager 852 corresponding to the PDA 851.

First, {Hnum: Number of hops} is updated by setting the number of hops=1. Then, an IP address=133.138.1.22 of the C-Manager itself having a reactive application is stored in {Reactive-ip: IP address of C-Manager which has a reactive application program} as the IP address of a C-Manager which has a reactively starting application.

Further, as {Anum: Number of attributes}, the number of attributes (Anum)=1 is set, which is necessary for performing a service program (control panel display in HTML), and an attribute (Attribute)=ur1 and a value (Value)=NULL are written. These values (Anum), (Attribute) and (Value) are information corresponding to the profile information (see FIG. 10) held by the C-Manager 852 corresponding to the PDA 851, and thus these values (Anum), (Attribute) and (Value) are acquired from that profile information using the service name {control/html} set in the Chain-Token as a key.

A part (c) in FIG. 17 shows a data configuration of the Chain-Token transmitted to the RC-Manager 853 corresponding to the PDA 851 from the C-Manager 862 corresponding to the video 861.

The part (c) shows a result of the data storage and updating process performed on the Chain-Token by the C-Manager 862 corresponding to the video 861.

First, {Hnum: Number of hops} is updated by setting 2 therein. Also, in {Anum: Number of attributes}, the number of attributes (Anum) necessary for performing the service program (control panel display in HTML) is updated to 2 from 1, and an attribute (Attribute)=url and a value (Value)=http://133.138.1.10/video.html are stored. This url is necessary to get HTML-based control panel display data.

In this way, by circulating the first Chain-Token from one C-Manager to another which correspond to the C-Objects participating in the service and then returning it to the RC-Manager, information necessary for implementing the service can be acquired.

When the first Chain-Token is returned, the RC-Manager, if finding any empty attribute, determines and inputs a value by interaction with the user via the user interface. When transmitting the second Chain-Token, the RC-Manager performs destination routing by giving to the C-Manager which has a program starting the service reactively, an address preceding to the other C-Manager. In the example of FIG. 17, the C-Manager 862 corresponding to the video 861 is addressed first.

The C-Manager having received the second Chain-Token starts the program of interest immediately, since all the information necessary for starting the program is ready. In order to control a program performed permanently, the C-Manager has process information of the performing program, and can forcibly terminate the program using the Chain-Token.

4. Process Flow for Applying Service-Chain

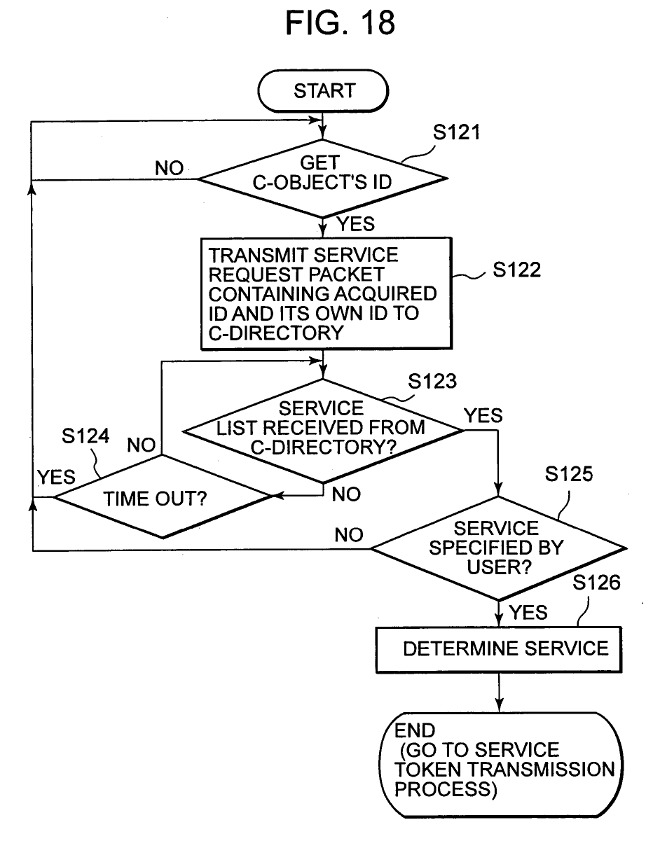

Referring next to flowcharts of FIGS. 18 through 21, a procedure of a process involving the above-mentioned Service-Chain will be described step by step.

(4.1) Step of determining service by RC-Manager

Referring first to a process flow of FIG. 18, steps performed to determine a service by a RC-Manager will be described.

First, in step S121, the RC-Manager gets the ID of a C-Object constituting the Service-Chain and necessary for performing a service. The ID may be acquired not Only via a network, but also via infrared, bar code and rfID, as mentioned above.

In step S122, a service request packet (see FIG. 13) is generated, in which the ID of the RC-Manager and the acquired ID of the other C-Object are stored, for transmission to a C-Directory.

In step S123, it is determined whether or not a service list is received as a service request reply frame (see FIG. 14) from the C-Directory. If not, the RC-Manager waits until it times out (step S124). When it times out, the RC-Manager, judging that neither acquired ID of the C-Object nor implementable service are available, returns to step S121.

When receiving the list from the C-Directory, the RC-Manager determines in step S125 whether or not the user has made a specification as to an available service. If not, the process returns to step S121. If the user has made a specification, the RC-Manager determines in step S126 a service for execution based on the user's specification.

When the service for execution is determined, a Chain-Token is generated according to the service for execution, and transmitted to C-Managers corresponding to C-Objects participating in the service.

(4.2) Step of replying to service request by C-Directory

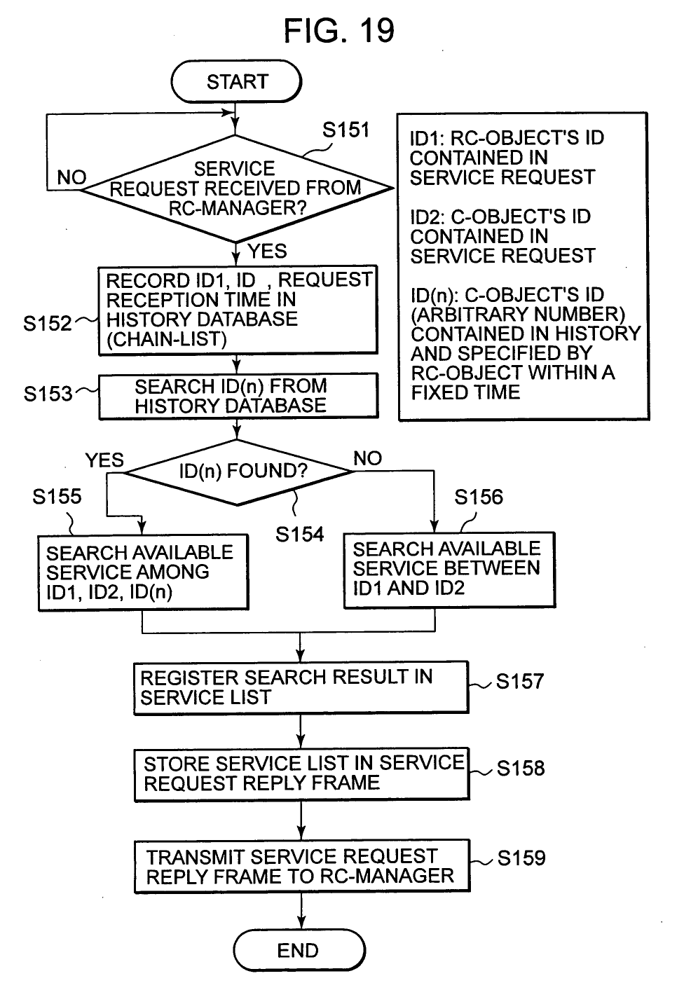

Referring then to FIG. 19, a step for replying to a service request will be described which is performed by the C-Directory having received the service request packet (see FIG. 13) from the RC-Manager.

As mentioned above, the RC-Manager must transmit, without exception, two IDs for a service request to the C-Directory. The first one is the ID of the RC-Object itself, and the second one is the ID of another C-Object acquired.

In step S151, the C-Directory determines whether or not a service request packet is received, and waits until it is received. When a packet is received, the ID (ID1) of the RC-Object and the ID (ID2) of another C-Object stored in the service request packet, and a packet reception time are stored in a Chain-List (see FIG. 7) as service request history information from the RC-Manager in step S152.

Next, in step S153, a search operation is performed to see whether or not the ID (IDn) of a C-Object combined with the ID of the same RC-Manager are found in the Chain-List as a history database. Note that the Chain-List as the history database stores data within a predetermined threshold time, and the data is deleted upon passage of the predetermined threshold time. Therefore, if the ID (IDn) of a C-Object combined with the ID (ID1) of the same RC-Manager is found in the Chain-List, it is determined that the service request packets are received successively from the same RC-Manager.

When it is determined in step S154 that the ID (IDn) of a C-Object combined with the ID (ID1) of the same RC-Manager is found in the Chain-List, then in step S155, service(s) is searched, which is implementable in all possible combinations of ID1, ID2 and ID(n).

The service search is made by referencing a service information database held by the C-Directory, i.e., the service information (see FIGS. 11 and 12) corresponding to the IDs of C-Objects, and checking any matching between service input (Service in) and service output (Service out). Specifically, in one example, a C-Object having an input file format of MPEG2 matches with a C-Object having an output file format of MPEG2, and an input/output service of MPEG2 image data will then be implemented.

In step S155, another search is made to find any service implementable in all possible combinations of ID1, ID2 and ID(n). On the other hand, if it is determined in step S154 that the ID (IDn) of a C-Object combined with the ID (ID1) of the same RC-Object is not found in the Chain-List, a search is made to find a service implementable in combinations only of ID1 and ID2 in step S156.

In step S157, a list is created as information about the searched service. The list includes information corresponding to the field 801 of the service request reply frame shown in FIG. 14. That is, the information includes Service name (Sname), {(In-id & In-ip): C-Object's ID and C-Manager's IP address for a service input} and {(Out-id & Out-ip): C-Object's ID and C-Manager's IP address for a service output}. These information is acquired from the service information database of the C-Directory. Note that if plural services are implementable, information corresponding to the field 801 in the service request reply frame shown in FIG. 14 is generated for each of the plural services.

Next, in step S158, the created service list is stored in the service request reply frame (see FIG. 14), and {T-id: Transaction ID} and {Snum: Number of available services} are further added to generate a service request reply frame.

Next, in step S159, the generated service request reply frame is transmitted to the RC-Manager.

(4.3) Process for Chain-Token by RC-Manager

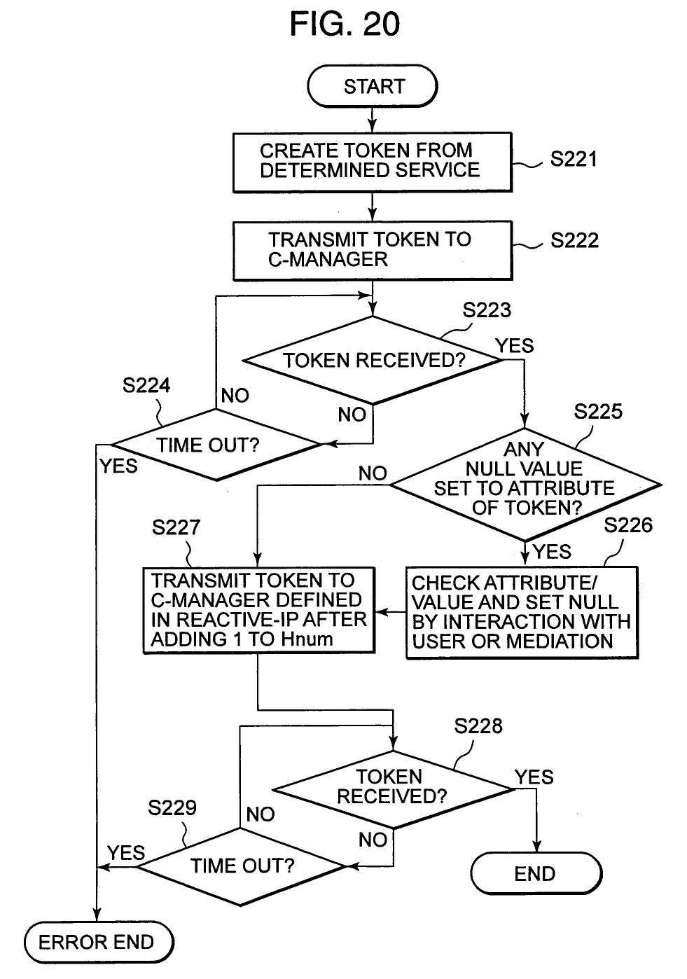

Referring next to a flow of FIG. 20, how a Chain-token is processed by the RC-Manager will be described.

The RC-Manager determines a service to be provided, for example, via interaction with a user, based on the service request reply frame received from the C-Directory. Once a service to be provided has been determined, the RC-Manager creates a Chain-Token in the format of FIG. 16 in step S221.

In step S222, the RC-Manager passes the generated Chain-Token among to C-Managers corresponding to C-Objects necessary for implementing the service, and then waits for the Chain-Token's return. If the Chain-Token does not return until it times out as predetermined (Yes in step S224), then the process is brought to an error end.

If the Chain-Token is received within the predetermined time, the received Token is verified in step S225, to determine if there is any attribute value {Value} set as {NULL}. If so, necessary information is set in step S226 via interaction with the-user or a mediation.

In step S227, the C-Manager corresponding to a C-Object necessary for implementing the service is caused to circulate a second Chain-Token containing all the necessary information, i.e., as a Chain-Token for requesting start of a program to perform the service. Note that at the time of transmitting the second Chain-Token, destination routing is performed by addressing first the C-Manager having the program for reactively starting the service.

Next, in step S228, return of the second Chain-token is waited for. If the Chain-Token does not return until it times out as predetermined (Yes in S229), then the process is brought to an error end. When the Chain-Token is received within the predetermined time (Yes in S228), the process is terminated.

As a result of this process, the C-Manager having received the second Chain-Token starts the program corresponding to the service, to perform the service.

(4.4) Process for Chain-Token by C-Manager

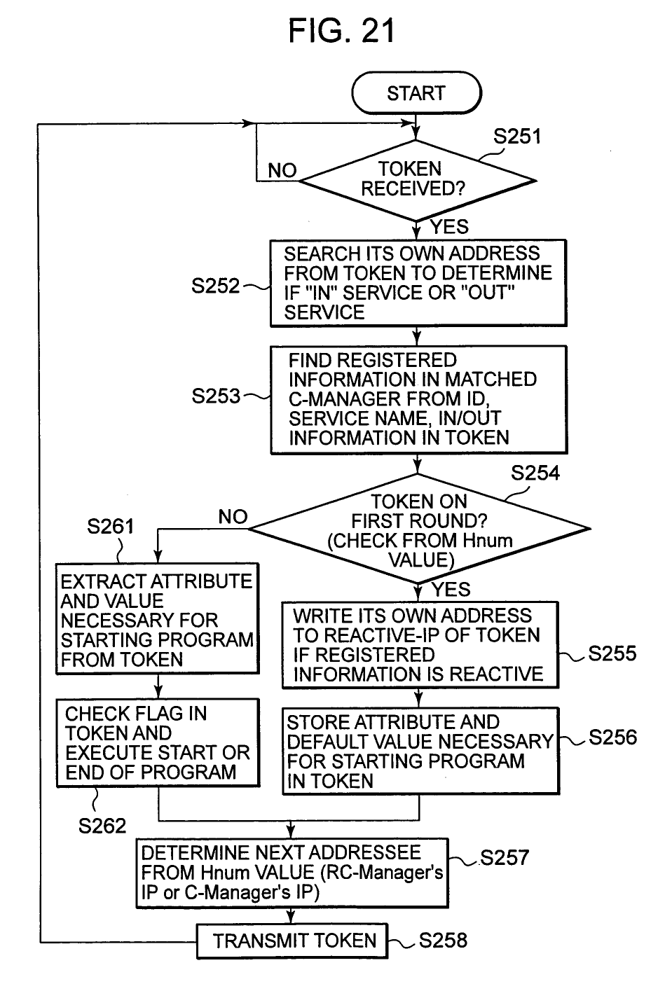

Referring next to a flow of FIG. 21, how the Chain-Tokens is processed by the C-Manager will be described.

The C-Manager receives the first or second Chain-Token from the RC-Manager, and performs a process based on each Chain-Token.

In step S251, when receiving the Chain-Token, the C-Manager looks for its own address within the received Chain-Token in step S252.

As described with reference to FIG. 16 or 17, the Chain-Token contains therein {In-id & In-ip: C-Object's ID and C-Manager's IP address for a service input} and {Out-id & Out-ip: C-Object's ID and C-Manager's IP address for a service output}, and the C-Manager determines whether it performs an input process or an output process based on the information contained these fields.

Next, in step S253, the corresponding information is searched from profiles (see FIGS. 10 and 11) held by the C-Manager based on the IDs, service name and in/out information set in the Chain-Token.

Next, in step S254, whether or not the received Chain-Token is the first token for collecting information is determined. This determination is made based on the number of hops (Hnum) set in the Chain-Token.

If the received Chain-Token is determined to be the first token, and when its profile corresponding to the service set in the Chain-Token is found to be {reactive} in step S255, its own IP address is set to {Reactive-ip: C-Manager which has a reactive application program} of the Chain-Token.

Further, in step S256, an attribute (Attribute) and a value (Value) necessary for starting the program are written, and in step S257, the next addressee of the Chain-Token, i.e., either the C-Manager or the RC-Manager is determined. This determination is made based on the number of hops (Hnum) set in the Chain-Token. In step S258, the Chain-Token is transmitted to the determined next addressee.

On the other hand, if it is determined in step S254 that the Chain-Token is the second token, then in step S261, an attribute (Attribute) and a value (Value) necessary for starting the program set in the Chain-Token are acquired, and in step S262, it is determined whether it is a request for starting or ending the program based on the flag set in the Chain-Token, and performs the process as requested.

Next, in step S257, the next addressee of the Chain-Token, i.e., either the C-Manager or the RC-Manager is determined. This determination is made based on the number of hops (Hnum) set in the Chain-Token. In step S258, the Chain-Token is transmitted to the determined next addressee.

5. Examples of How Service-Chain is Used

A greatest advantage of utilizing the above-mentioned Service-Chain is a high level of expendability and convenience. It would be possible to operate information processing apparatuses to be manufactured in the future or objects other than the information processing apparatuses as C-Objects on the basis of the service-Chain. Further, since the Service-Chain is not designed to be dedicated to a particular service, existing C-Objects can be easily connected to one another as long as their data formats are compatible, whereby services to which the mutually connected objects are applied can be implemented. Specifically, the following forms of services would be envisioned.

(a) Added Information Distribution Service

A scheme of acquiring added information of something in the real world, such as annotations of a Web page, can be easily provided. For example, by reading the ID of a poster, detailed information about the poster is obtained, or information could be registered using an employee number. Services such as displaying a Web page by reading bar code information could further be implemented by the Service-Chain where the above-mentioned C-Objects are connected to one another.

(b) Inter-Apparatus Connection Support Service

Nowadays, ordinary homes are crowded with machines such as video apparatus, televisions, DVDs and audio apparatus as a matter of course. Further, in the world of the Internet, there are so many video formats that it is not easy for us to tell which apparatus supports which format. In the Service-Chain, an easy operation of reading the ID of apparatus allows a user to know which service can be implemented or cannot be implemented by the apparatus as a C-Object. Therefore, the Service-Chain can provide only data that can be processed to allow the data to be processed, without troubling the user to learn detailed information about each apparatus.

(c) Real World-Oriented Interface

In the Service-Chain, a C-Manager actually providing services can be considered separate from a C-Object. For example, as to a service {text/html} that is to display text information in HTML, if a user wishes to display the information on a wall as a C-Object, the ID set on the wall as the C-Object is read. Assigning a projector, i.e., another C-Object to actually perform the process of displaying the data on the wall, the wall and the projector are connected through the Service-Chain. The C-Managers corresponding to the respective C-Objects can start a program for performing the service {text/html} for displaying the text information in HTML.

The projector might be projecting the HTML data via a personal computer. However, the user does not have to care about how the data is projected on the wall. That is, the computer is not seen any more as it has been assimilated into a ubiquitous world, and it is implementing data processing in the ubiquitous world.

While the present invention has been described above in detail with reference to its preferred embodiment, it is self-explanatory that the disclosed embodiment is merely exemplary and that those skilled in the art can make modifications and substitutions thereof without departing from the scope and spirit of the invention which should not be construed in a restrictive sense but should be construed as defined by the appended claims.

It should be noted that the processes disclosed herein may be performed by hardware, software, or a combination of both. In a software configuration, software may be provided in a computer having dedicated hardware into which a program constituting the software is incorporated, or alternatively by storing the program in a program-readable recording medium such as a flexible disc or a CD for installation to, for example, a general-purpose computer which can perform various functions by installing various programs. Or the software may also be downloaded via a communication network such as the Internet.

Specifically, the program can be recorded in a hard disk and a ROM as recording media beforehand. Alternatively, it can be stored (or recorded) temporarily or permanently on a removable recording medium such as a flexible disc, a CD-ROM (Compact Disc Read Only Memory), a MO (Magneto-Optical) disc, a DVD (Digital Versatile Disc), a magnetic disc, or a semiconductor memory. Such a removable recording medium may be provided as so-called package software.

Also, the program may be installed to a computer from a removable recording medium such as mentioned above, wirelessly forwarded to the computer from a download site, or forwarded to the computer wired via a network, such as a LAN or the Internet, whereas the computer receives the thus forwarded program for installation to a recording medium such as a built-in hard disk.

Furthermore, the various processes disclosed herein may be performed time-serially according to the disclosure, or may also be performed in parallel or individually, according to the processing capability of an apparatus performing the processes, or as necessary.

It should be understood by those skilled in the art that various modifications, combinations, sub-combinations and alterations may occur depending on design requirements and other factors insofar as they are within the scope of the appended claims or the equivalents thereof.

What is claimed is:

1. a data processing system comprising:
a plurality of chain managers for performing control of a data input and/or data output service, the data input and the data output service handling data associating with one or more chain objects and having a predefined file format and/or data type;
a chain directory for storing correspondence data and performing an executable service retrieval process, the correspondence data storing correspondence relations among identifiers (ID) set on the chain managers, identifiers (ID) of chain objects associating with the chain mangers, data input and/or data output services associated with the chain objects, and file formats and/or data types that can be used in the data input and/or data output services, the executable service retrieval process being performed by matching of the file formats and/or data types and matching of the data input and the data output services; and
a root chain manager for acquiring one chain object ID and performing a query process to the chain directory, the query process inquiring a chain object that uses the data output or data input service having the same file format and/or data type as that of the data input or data output service associating with the chain object with the acquired ID;
wherein the chain manager ID and the chain object ID are identifiers that are defined in address spaces different from each other.

2. The data processing system according to claim 1, wherein:
the root chain manager is configured to generate a service query packet to perform the query process to the chain directory; and
the chain directory is configured to generate a chain list that records packet reception time information of the service query packet received from the root chain manager and ID information stored in the service query packet, perform an executable service retrieval process for searching an service that is executable among two chain objects that can be combined based on the IDs recorded in the chain list, and generate a reply to the service query packet based on a result of the executable service retrieval process, the executable service retrieval process being performed if another service query packet storing a different chain object ID is received from the same root chain manager within a predetermined threshold time.

3. The data processing system according to claim 1, wherein:
the chain manager ID is an ID that is applicable as a communication address.

4. The data processing system according to claim 1, wherein:
the root chain manager is configured to control the service execution by circulating a chain token among the chain managers corresponding to the chain objects participating in the service based on the reply to the service query packet to the chain directory.

5. The data processing system according to claim 1, wherein:
the root chain manager is configured to control the service execution by circulating a first and a second chain tokens among the chain managers corresponding to the chain objects participating in the service, the first chain token being for acquiring program information necessary for performing the service and the second chain token being for requesting start of the program corresponding to the service execution process.

6. The data processing system according to claim 1, wherein:
the chain manager is configured to: store an ID of the chain object that is managed by the present chain manager and service profile information as executable service information; performs an ID notification process for the ID of the chain object to be managed based on the service profile information in response to the request of an ID acquisition process from the root chain manager; and performs a data storage process and a program triggering process, the data storage process being performed for a received chain token based on the service profile information in response to the received chain token from the root chain manager, and the program triggering process being performed based on the received chain token.

7. An information processing apparatus serving as a chain manager arranged so as to correspond to each of a plurality of chain objects, the chain object being arranged within a service chain that is included in a data processing system, the information processing apparatus comprising:
memory means for storing an ID set on the chain object, and service profile information as executable service information; and
control means for performing a data storage process for a received chain token and a program triggering process based on the received chain token, based on the service profile information in response to the chain token received from a root chain manager arranged within the service chain.

8. The information processing apparatus according to claim 7, wherein:
the control means is configured to perform a process for storing program information, which is required for performing a service stored in the service profile information, in a first chain token received from the root chain manager for acquiring the program information required for performing the service.

9. The information processing apparatus according to claim 7, wherein:
the control means is configured to acquire program information necessary for performing a service stored in a second chain token in response to reception of the second chain token, which is received from the root chain manager for requesting start of a program corresponding to a service execution process, and perform a program execution process based on the acquired program information.

10. An information processing apparatus serving as a root chain manager for performing control of data processing service involving a plurality of chain objects, the chain objects being arranged in a service chain that is included in a data processing system, the information processing apparatus comprising:
control means for performing an ID acquisition process for the chain objects; generating a service query packet for inquiring an executable data processing service to which the chain object with the acquired ID is applied; transmitting the service query packet to a chain directory that has service information; and circulating a chain token among chain managers arranged so as to correspond to chain objects participating in the service based on a reply to the query packet; thereby performing control of service execution.

11. The information processing apparatus according to claim 10, wherein:
the information processing apparatus is configured to perform a process of circulating a first and a second chain tokens among the chain managers corresponding to the chain objects participating in the service, the first chain token being for acquiring program information necessary for performing the service, the second chain token being for requesting start of a program corresponding to a service execution process.

12. An information processing apparatus serving as a chain directory for performing an information providing process as to a data processing service involving a plurality of chain objects arranged in a service chain that is included in a data processing system, the information processing apparatus comprising:
a database for storing service information executable by each chain object in association with an ID of the chain object; and
control means for performing a retrieval process on the database that stores the service information in response to a service query packet storing a plurality of chain object IDs based on the IDs, and generating a service query reply packet that stores executable service information acquired as a result of the retrieval process.

13. The information processing apparatus according to claim 12, wherein:
the information processing apparatus is configured to have information, as the service information, which indicates association of an ID of each chain object, service information executable by each of the chain objects, and address information of the chain manager arranged on the chain object; and to search the service information that corresponds to the chain object IDs stored in the service query packet based on the service information in response to reception of the service query packet, generate a service query reply packet storing the searched service information, and transmit the service query reply packet to the root chain manager.

14. The information processing apparatus according to claim 12, wherein:
the service information stored in the database includes a service type and a data format that can be processed, the service type indicating whether a service executable by each of the chain objects is a data input mode or a data output mode; and
the control means is configured to perform a matching process for searching a combination of the same data formats that allow a data input and a data output among the service information corresponding to the chain object IDs stored in the service query packet in response to the received service query packet, and generate a reply to the service query packet, the reply including the matched service as an executable data processing service.

15. The information processing apparatus according to claim 12, wherein:
the control means is configured to generate a chain list recording packet reception time information in response to reception of the service query packet received and ID information stored in the service query packet, perform an executable service retrieval process for searching an service that is executable among two chain objects that can be combined based on the IDs recorded in the chain list, and generate a reply to the service query packet based on a result of the executable service retrieval process, the executable service retrieval process being performed if another service query packet storing a different chain object ID is received from the same root chain manager within a predetermined threshold time.

16. A data processing method for a service chain including a plurality of chain objects, the each chain object being given a unique ID, the data processing method comprising:
an ID acquiring step for acquiring an ID of the chain object;
a query execution step for transmitting a service query packet storing the ID acquired by the ID acquiring step to a chain directory that has service information;
a query reply step for searching service information corresponding to the chain object ID stored in the service query packet based on the chain object IDs in the service query packet, performing a retrieval process to search an executable service involving chain objects by performing a matching process for searching a combination of the same data formats allowing a data input and a data output, generating a service query reply packet storing service information as the search result, and replying to a sender of the query; and
a control step for performing control of service execution by circulating a chain token among chain managers corresponding to the chain objects participating in the service based on the information stored in the service query reply packet.

17. The information processing method according to claim 16, wherein:
the control step includes a process step for circulating a first and a second chain tokens among the chain managers corresponding to the chain objects participating in the service, the first chain token being for acquiring program information necessary for performing the service, the second chain token being for requesting start of the program corresponding to the service execution process.

18. The information processing method according to claim 16, wherein:
the control step includes a step for causing the chain manager to store information necessary for performing a program corresponding to the data processing service in the received chain token.

19. The information processing method according to claim 16, wherein:
the control step includes a step for causing the chain manager to perform a program triggering process based on the received chain token.

20. The information processing method according to claim 16, wherein:
the query reply step includes a step for generating a chain list recording a reception time information of the service query packet and ID information stored in the service query packet, and
a step for performing executable service retrieval process for searching an service that is executable among two chain objects that can be combined based on the IDs recorded in the chain list, and generating a reply to the service query packet based on a result of the executable service retrieval process, the executable service retrieval process being performed if another service query packet storing a different chain object ID is received from the same root chain manager within a predetermined threshold time.

21. A data processing method performed by a chain manager arranged so as to correspond to each of a plurality of chain objects that are included in a service chain, the chain object being given a unique ID, the data processing method comprising:
a memory step for storing an ID set on the chain object and service profile information as executable service information; and
a control step for performing a data storage process to a received chain token based on the service profile information in response to the chain token received from the root chain manager, and a program triggering process based on the received chain token.

22. The information processing method according to claim 21, wherein:
the control step includes a process step for storing program information, which is necessary for performing a service stored in the service profile information, to a first chain token received from the root chain manager for acquiring the program information necessary for performing the service.

23. The information processing method according to claim 21, wherein:
the control step includes a step for acquiring program information necessary for performing a service, which is stored in a second chain token received from the root chain manager for requesting start of a program corresponding to a service execution process, and performing a program execution process based on the acquired information, in response to the reception of the second chain token.

24. A data processing control method for a data processing service involving a plurality of chain objects that are included in a service chain, each chain object being given a unique ID, the data processing control method comprising:
a step for performing an ID acquisition process for the chain object;
a step for generating a service query packet regarding an executable data processing service involving a chain object having the acquired ID, and transmitting it to a chain directory that has service information; and
a control step for performing control of the service execution by circulating a chain token among chain managers arranged so as to correspond to the chain objects participating in the service based on a reply to the service query packet.

25. The information processing method according to claim 24, wherein:
the control step includes a process step for circulating a first and a second chain tokens among the chain managers corresponding to the chain objects participating in the service, the first chain token being for acquiring program information necessary for performing the service, the second chain token being for requesting start of the program corresponding to the service execution process.

26. An information provision processing method for a data processing service involving a plurality of chain objects arranged in a service chain that is included in a data processing system, the information provision processing method comprising:
a step for receiving a service query packet storing a plurality of chain object IDs;
a search step for performing a retrieval process in a database based on the IDs stored in the service query packet, wherein the database stores service information executable by each chain object in association with the chain object IDs;
a step for generating a service query reply packet storing executable service information acquired as a result of the retrieval process; and
a step for transmitting the service query reply packet.

27. The information processing method according to claim 26, wherein:
the service information stored in the database includes a service type and a data format that can be processed, the service type indicating whether a service executable by each of the chain objects is a data input mode or a data output mode; and
the search step includes steps for performing a matching process for searching a combination of the same data formats that allow a data input and a data output among the service information corresponding to the chain object IDs stored in the service query packet, and extracting a matched services as an executable data processing service.

28. The information processing method according to claim 26, further comprising:
process steps for generating a chain list recording packet reception time information in response to reception of the service query packet received and ID information stored in the service query packet; performing an executable service retrieval process for searching an service that is executable among three or more chain objects, that include the ID recorded in the chain list; and generating a reply to the service query packet based on a result of the executable service retrieval process, the executable service retrieval process being performed if another service query packet storing a different chain object ID is received from the same root chain manager within a predetermined threshold time.

29. A computer program for performing a data process performed by a chain manager arranged so as to correspond to each of a plurality of chain objects that are included in a service chain, the chain object being given a unique ID, the computer program comprising:
a memory step for storing an ID set on the chain object and service profile information as executable service information; and
a control step for performing a data storage process to a received chain token based on the service profile information in response to the chain token received from the root chain manager, and a program triggering process based on a received chain token.

30. A computer program for performing a data processing control process for a data processing service involving a plurality of chain objects that are included in a service chain, each chain object being given a unique ID, the computer program comprising:
a step for performing an ID acquisition process for the chain object;
a step for generating a service query packet regarding an executable data processing service involving a chain object having the acquired ID, and transmitting it to a chain directory that has service information; and
a control step for performing control of the service execution by circulating a chain token among chain managers arranged so as to correspond to the chain objects participating in the service based on a reply to the service query packet.

31. A computer program for performing an information providing process for a data processing service involving a plurality of chain objects arranged in a service chain that is included in a data processing system, the computer program comprising:
a step for receiving a service query packet storing a plurality of chain object IDs;
a step for searching service information corresponding to a chain object ID stored in the service query packet based on the chain object IDs in the service query packet, performing a retrieval process to search an executable service involving chain objects by performing a matching process for searching a combination of the same data formats allowing a data input and a data output, and generating a service query reply packet storing the service information as the search result; and
a step for transmitting the service query reply packet.
